(19) United States
(12) Patent Application Publication
(10) Pub. No.: US 2006/0061708 A1
(43) Pub. Date: Mar. 23, 2006

(54) Microlens array, method of fabricating microlens array, and liquid crystal display apparatus with microlens array

(75) Inventors: Nobuhiro Umebayashi, Osaka (JP); Masahiro Kishigami, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/226,365

(22) Filed: Sep. 15, 2005

(30) Foreign Application Priority Data
Sep. 17, 2004 (JP) 2004-270966
Nov. 5, 2004 (JP) 2004-322697

(51) Int. Cl. G02F 1/1335

(52) U.S. Cl. 349/95

(57) ABSTRACT

A method of fabricating a microlens array first forms a photosensitive resin layer on the surface of a transparent substrate opposite from the surface having aperture portions. It then places an exposure substrate and the transparent substrate so that parallel light having an intensity distribution corresponding to a shape of an exposure microlens array is focused by the exposure microlens array and enters the transparent substrate through the aperture portions. After that, the method exposes the photosensitive resin layer by applying the parallel light to the photosensitive resin layer through the exposure substrate. Then, it develops the exposed photosensitive resin layer.

### BACKGROUND OF THE INVENTION

1. Field of the Invention

The present invention relates to a microlens array, a method of fabricating the microlens array, and a liquid crystal display apparatus having the microlens array.

2. Description of Related Art

A technique that uses a microlens array in a liquid crystal display apparatus is proposed in order to achieve high luminance and wide viewing angle.

A liquid crystal display apparatus includes a pair of transparent substrates with a liquid crystal layer interposed therebetween. A polarizing film is provided in the front side of the transparent substrate. A black matrix, a color filter, a transparent electrode and an alignment layer are formed in the back side of the transparent substrate. A spacer is placed between the two transparent substrates. A thin film transistor (TFT), a transparent substrate and an alignment layer are formed in the front side of the transparent substrate.

A microlens array and a rim are formed in the back side of the transparent substrate. The microlens array collects the light emitted from a light source and incoming through the polarizing film and applies the light to the transparent substrate by getting around the TFT and the black matrix, thereby increasing light use efficiency to achieve high luminance.

Japanese Unexamined Patent Publication No. 08-166502 discloses a method of fabricating a microlens array on a quartz glass. However, it does not disclose a method of fabricating a microlens array on a transparent substrate where TFT and transparent electrode are formed.

Further, Japanese Unexamined Patent Publication No. 2003-294912 and 2004-252376 disclose a method of fabricating a microlens array. However, they also do not disclose a method of fabricating a microlens array on a transparent substrate where TFT and transparent electrode are formed.

The above methods form a microlens shape by modulating the intensity of exposure light with an optical mask such as a gray scale mask. Such a gray scale mask is fabricated by the method described in Japanese Patent Translation Publication No. 2002-525652, for example. Japanese Patent Translation Publication No. 60-501950 discloses a method of forming a structure with a desired continuous variable surface relief by using an adjust exposure mask. This method forms a shape whose thickness changes continuously by exposing a photoresist layer with UV light through a UV absorbent material layer with a continuously changing thickness. The adjust exposure mask is patterned by an electron beam.

Japanese Unexamined Patent Publication No. 2003-294912 also discloses a special photosensitive plate on which a mask pattern can be drawn by using a high energy beam. This plate has an ion exchange layer that contains concentrated silver ion as a photosensitive material. The ion exchange layer is colored by exposing a high energy beam, and such characteristics allow creation of a mask pattern. The high energy beam may be an electron beam, ion beam, molecular beam, X-ray beam and so on.

On the other hand, a technique that fabricates a circuit substrate by laser exposure on a dry glass plate is known. This method patterns a circuit surface by selectively exposing the surface with a laser beam. A conventional technique of patterning on the dry glass plate generally either leaves or removes the pattern and does not change light transmittance in stages or in succession like a gray scale mask.

To improve productivity to form microlens arrays, it is preferred to form a large number at the same time by one-shot exposure on a large area as described above. This requires a large area of gray scale mask used for exposure. However, when using an electron beam during fabrication process as in Japanese Unexamined Patent Publication No. 08-166502 and 2003-294912, the processing cannot be performed in the air but should be performed in vacuum. Thus, formation of a large gray scale mask requires making the same area of space in vacuum state, but it is difficult to keep the large space in vacuum state and it costs high. Further, a high energy beam such as an electron beam is expensive as a light source. Thus, the conventional techniques have a problem in costs and productivity.

The fabrication method described in Japanese Patent Translation Publication No. 2002-525652 needs to perform deposition, patterning and dry etching, thus requiring a large number of process steps. Further, the fabrication method described in Japanese Patent Translation Publication No. 60-501950 requires a special plate of a high energy beam sensitive glass. These factors cause an increase in costs and a decrease in productivity.

In order to achieve high luminance by placing a microlens array in a liquid crystal display apparatus, it is necessary to align the lens optical axis of a microlens array with the aperture portion of a black matrix and to get around TFT. Thus, the microlens array needs to be accurately positioned with respect to the black matrix and the TFT. Since the lens pattern of the microlens array is very fine, the optical axis alignment requires an accuracy of ±1 μm order. This causes an increase in costs and a decrease in productivity.

### SUMMARY OF THE INVENTION

The present invention has been accomplished to solve the above problems and an object of the present invention is thus to provide a microlens array and a liquid crystal display apparatus that allow easy alignment of the optical axis in a microlens array fabrication process and produce high productivity.

To these ends, according to one aspect of the present invention, there is provided a method of fabricating a microlens array on a surface of a transparent substrate whose another surface has a wiring pattern formed to have a plurality of aperture portions at a predetermined interval by using an exposure substrate composed of a transparent supporting substrate and an exposure microlens array formed thereon; the method comprising: forming a photosensitive resin layer on the surface of the transparent substrate opposite from the surface having the aperture portions; placing the exposure substrate and the transparent substrate so that parallel light having an intensity distribution corresponding to a shape of the exposure microlens array is focused by the exposure microlens array and enters the transparent substrate through the aperture portions; exposing the photosensitive resin layer by applying the parallel light to the photosensitive resin layer through the exposure substrate; and developing the exposed photosensitive resin layer.

The parallel light having the intensity distribution is obtained by passing the parallel light through a gray scale mask having a plurality of mask patterns where light transmittance changes from a center to a periphery.

According to another aspect of the present invention, there is provided a method of fabricating a microlens array on a first surface of a transparent substrate having a second surface where a wiring pattern is formed to have a plurality of aperture portions at a predetermined interval, the method comprising: placing a gray scale mask having a plurality of mask patterns where light transmittance changes from a center to a periphery and an exposure substrate where microlenses are formed corresponding one to one with the mask patterns of the gray scale mask on a transparent supporting substrate on the second surface of the transparent substrate having the aperture portions so that each aperture portion, an optical axis of each microlens, and a center of each mask pattern are aligned, and light applied through the gray scale mask is focused by the exposure substrate and output from the aperture portions; forming a photosensitive resin layer on the first surface of the transparent substrate; and exposing the photosensitive resin layer by applying light through the exposure substrate and developing the photosensitive resin layer.

It is preferred that the exposure substrate has a positioning member defining a space between the exposure microlens array and the surface of the transparent substrate having the wiring pattern, and if a thickness of the transparent substrate is t₁, a refractive index of the transparent substrate is n₁, a thickness of the positioning member is t₂, and a refractive index of the positioning member is n₂, a focal length of the exposure microlens array is substantially the same as t₂, and a following condition is satisfied: 0.75<(t₁*n₁)/(t₂*n₂)<1.25.

Further, it is preferred that if given coordinate positions of a plane perpendicular to an optical axis of exposure light to expose the photosensitive resin layer are represented by x and y, a light intensity distribution of exposure light having passed through the gray scale mask and the exposure substrate is represented by Z, and a, b and c represent given real numbers, a following condition is satisfied:
Z=ah2+bh4+ch6, and h=(x2+y2)½.

The positioning member may have a light shielding pattern on a surface different from the surface having the exposure microlens. In this case an aperture portion of the light shielding pattern and an optical axis of the exposure microlens preferably substantially correspond in a vertical direction.

The exposure substrate and the gray scale mask may be integrally formed.

The exposure substrate and the transparent substrate may be placed with an air space therebetween. If a thickness of the transparent substrate is t₁, a refractive index of the transparent substrate is n₁, and a thickness of the air space is t₃, a focal length of the exposure microlens is preferably substantially the same as t₃, and a following condition is preferably satisfied: 0.75<(t₁*n₁)/t₃<1.25.

According to another aspect of the present invention, there is provided a method of fabricating a microlens array on a first surface of a transparent substrate having a second surface where a circuit element pattern having a plurality of aperture portions is formed, the method comprising: forming a photosensitive resin layer on the first surface of the transparent substrate; placing an exposure substrate where a plurality of exposure microlenses are formed at substantially the same pitch as a pitch of the aperture portions on the second surface of the transparent substrate; placing a gray scale mask where a plurality of lens formation areas are formed at substantially the same pitch as the pitch of the aperture portions on the second surface of the transparent substrate; exposing the photosensitive resin layer through the gray scale mask and the exposure substrate; and developing the exposed photosensitive resin layer.

According to another aspect of the present invention, there is provided a grayscale mask with a lens wherein a gray scale mask is formed on one surface of a supporting substrate having transparency, and an exposure microlens corresponding to a mask pattern of the gray scale mask is formed on another surface of the supporting substrate. According to still another aspect of the present invention, there is provided a grayscale mask with a lens wherein a gray scale mask is formed on one surface of a supporting substrate having transparency, and an exposure microlens corresponding to a mask pattern of the gray scale mask is formed on the gray scale mask.

It is preferred that the mask pattern is composed of same lens formation areas, and if given coordinate positions on a plane parallel to the substrate are represented by x and y whose origin is a center of the lens formation areas, a light intensity distribution of light having passed through the lens formation areas on the plane parallel to the substrate is represented by Z, Cn represents a given real number, m represents a given natural number, and k is zero or a given positive real number, a following condition is satisfied:

$$\begin{matrix}Z = k - {\sum }_{n = 1}^{m} {C}_{n} {h}^{2 n} & ( 1 ) \\ h = {( {x}^{2} + {y}^{2} )}^{1 / 2} \\ n = 1 , 2 , 3 , 4 , ⋯ & ( 2 )\end{matrix}$$

The grayscale mask with a lens may further comprise a positioning member defining a space between an exposed substrate and the exposure microlens in exposure.

According to another aspect of the present invention, there is provided a method of fabricating a gray scale mask, comprising: forming an original gray scale mask by coating photoemulsion on a transparent substrate; placing a master gray scale mask having a master pattern with gradation on a predetermined position of the original gray scale mask; exposing the original gray scale mask through the master pattern; repeating the placing the master gray scale mask on an unexposed position of the original gray scale mask and the exposing the original gray scale mask until exposure on all areas to be exposed is completed: and developing the original gray scale mask.

The master gray scale mask may be placed on a predetermined position of the original gray scale mask through an alignment substrate.

The alignment substrate may have a marking for positioning the master gray scale mask so that the master gray scale mask is placed on a predetermined position on the original gray scale mask by using the marking.

Further, the alignment substrate may have a light shielding effect and include a plurality of aperture portions corresponding to a size of the master pattern, and the master gray scale mask may be placed on the original gray scale mask so that the master pattern faces the aperture portions.

According to another aspect of the present invention, there is provided a method of fabricating a gray scale mask with gradation, comprising: forming a dry plate by coating photoemulsion on a transparent substrate; and applying laser light whose intensity is modulated in a plurality of tones according to the gradation onto the emulsion-coated surface of the dry plate.

According to another aspect of the present invention, there is provided a gray scale mask with gradation composed of a transparent substrate coated with photoemulsion and developed, wherein the gradation comprises a continuous pattern of circular or polygonal shapes, and one circular or polygonal shape has light transmittance sequentially changing to increase or decrease from a center to a periphery.

If coordinate positions on a principal plane of the gray scale mask are represented by x and y whose origin is a center of a pattern corresponding to one microlens, a light intensity distribution of light having passed through the pattern on the principal plane of the gray scale mask is represented by Z, Cn represents a given real number, m represents a given natural number, and k is zero or a given positive real number, a following condition is preferably satisfied:

$$\begin{matrix}Z = k - {\sum }_{n = 1}^{m} {C}_{n} {h}^{2 n} & ( 1 ) \\ h = {( {x}^{2} + {y}^{2} )}^{1 / 2} \\ n = 1 , 2 , 3 , 4 , ⋯ & ( 2 )\end{matrix}$$

According to another aspect of the present invention, there is provided a semi-transmissive liquid crystal display apparatus, comprising a liquid crystal layer; and a transparent substrate whose one surface has a pixel electrode including a reflecting portion and an aperture portion and whose another surface has a plurality of microlenses directly formed by photocurable resin and having a noncircular bottom shape, wherein an aperture ratio of the aperture portion is in a range of 5% to 50%, a filling rate of the microlenses with respect to a display area of the liquid crystal display apparatus is 70% and higher, and if a maximum curvature radius of a lens section at a given line segment passing through a lens center of the microlenses is R1, and a minimum curvature radius of the same is R2, a ratio of R1 and R2 is in a range of 0.82 to 1.0.

It is preferred that a filling rate of the microlenses with respect to the display area of the liquid crystal display apparatus is 80% and higher, the aperture ratio of the aperture portion is in a range of 5% to 20%, and the ratio of R1 and R2 is in a range of 0.9 to 1.0.

Further, if a curved line of a section of a given line segment passing through the lens center of the microlenses and connecting both ends of the microlens is r1 and a curved line of a spherical surface after fitting by method of least squares on r1 is r2, rms value of a difference between r1 and r2 is preferably in a range of 0.005 to 0.2, and more preferably in a range of 0.005 to 0.15.

Furthermore, a backlight is preferably placed so that an emitting surface faces the surface of the transparent substrate having the microlens.

According to another aspect of the present invention, there is provided a semi-transmissive liquid crystal display apparatus comprising: a liquid crystal layer; a transparent substrate whose one surface has a pixel electrode including a reflecting portion and an aperture portion and whose another surface has a microlens aligned one to one with the aperture portion, and a backlight unit placed so that an emitting surface faces the surface of the transparent substrate having the microlens, wherein an angle of an emission component of light from the backlight unit whose intensity is 20% of light intensity of a vertical component is defined as an emission angle θ of the backlight unit, a thickness of the transparent substrate to the backlight unit is t, an average length from a center of the aperture portion to a periphery of the aperture portion is p/2, and a refractive index of the transparent substrate and/or the microlens is n, 0.85≦(φ*n)/(θ*t).

It is preferred that a bottom shape of the microlens is hexagon or rectangle, the microlens is formed directly on the transparent substrate, and (φ*n)/(θ*t)≦1.75 is satisfied.

The present invention provides a microlens array and a liquid crystal display apparatus that allow easy alignment of the optical axis of a microlens array and produce high productivity.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a sectional view of a liquid crystal display apparatus according to the present invention;

FIG. 2 is a schematic diagram showing the structure of wiring, reflective electrode, and transparent electrode of a liquid crystal display apparatus according to an embodiment of the present invention;

FIG. 3 is a plan view showing the arrangement of a transparent substrate, microlens array, and rim;

FIGS. 4A and 4B are sectional views showing the function of a microlens according to an embodiment of the present invention;

FIG. 5 is a perspective view showing patterning on a dry plate according to an embodiment of the present invention;

FIG. 6 is a top view showing a master gray scale mask according to an embodiment of the present invention;

FIG. 7 is a perspective view showing a mother gray scale mask and a gray scale mask according to an embodiment of the present invention;

FIG. 8 is a perspective view showing a fabrication process of a gray scale mask according to an embodiment of the present invention;

FIG. 9 is an enlarged perspective view showing a fabrication process of a gray scale mask according to an embodiment of the present invention;

FIGS. 10A to 10D are sectional views showing fabrication processes of a gray scale mask according to an embodiment of the present invention;

FIGS. 11A and 11B are graphs showing the intensity distribution of exposure light after passing through a unit lens according to an embodiment of the present invention;

FIG. 12 is a sectional view of a mother gray scale mask with a lens according to an embodiment of the present invention;

FIGS. 13A to 13C are sectional views showing a fabrication process of a mother gray scale mask with a lens according to an embodiment of the present invention;

FIGS. 14A to 14C are views showing a fabrication process of a microlens on a liquid crystal panel substrate according to an embodiment of the present invention;

FIG. 15 is a plan view of a mother substrate of a liquid crystal panel substrate according to an embodiment of the present invention;

FIG. 16 is a perspective view showing a fabrication process of a gray scale mask according to an embodiment of the present invention;

FIG. 17 is an enlarged perspective view showing a fabrication process of a gray scale mask according to an embodiment of the present invention;

FIG. 18 is a sectional view of a mother gray scale mask with a lens according to an embodiment of the present invention;

FIGS. 19A and 19B are sectional views showing a fabrication process of a microlens on a liquid crystal display panel according to an embodiment of the present invention;

FIG. 20 is a view showing an exposure substrate according to an embodiment of the present invention;

FIGS. 21A and 21B are sectional views of a mother gray scale mask with a lens according to an embodiment of the present invention;

FIGS. 22A and 22B are sectional views of a mother gray scale mask with a lens according to an embodiment of the present invention;

FIG. 23 is a view showing component arrangement in a process of fabricating a microlens array on a transparent substrate according to an embodiment of the present invention;

FIG. 24 is a view showing exposure light in a process of fabricating a microlens array on a transparent substrate according to an embodiment of the present invention;

FIGS. 25A to 25D are sectional views showing a microlens according to an embodiment of the present invention;

FIG. 26 is a graph showing a degree of sphericity of a microlens according to an embodiment of the present invention;

FIGS. 27A and 27B are perspective views showing a microlens and a microlens array, respectively, according to an embodiment of the present invention;

FIG. 28 is a table comparing characteristics between a liquid crystal display apparatus according to an embodiment of the present invention and a liquid crystal display apparatus according to a comparative example and a conventional example;

FIG. 29 is a schematic sectional view showing a liquid crystal panel and a backlight unit according to an embodiment of the present invention;

FIGS. 30A to 30C are schematic sectional views showing a prism sheet according to an embodiment of the present invention;

FIGS. 31A and 31B are schematic views showing a difference in focal point due to the thickness of a transparent substrate to describe light focusing effect of a microlens according to an embodiment of the present invention;

FIG. 32 is a graph showing the intensity distribution of light after vertically polarized by a prism sheet according to an embodiment of the present invention;

FIG. 33 is a plan view showing a pixel electrode and a spot diameter of luminous flux when the light focused by a microlens reaches a pixel electrode according to an embodiment of the present invention;

FIG. 34 is a graph showing the intensity distribution of light when the light focused by a microlens reaches a pixel electrode by standardizing a vertical component to 1 according to an embodiment of the present invention;

FIG. 35 is a graph showing the intensity distribution of light when the light focused by a microlens reaches a pixel electrode according to an embodiment of the present invention;

FIG. 36 shows values indicating correspondence between light use efficiency and parameters according to an embodiment of the present invention;

FIG. 37 is a graph showing-relationship between light use efficiency and parameters according to an embodiment of the present invention; and

FIG. 38 is a schematic sectional view showing a backlight unit according to an embodiment of the present invention.

### DESCRIPTION OF THE PREFERRED EMBODIMENTS

The preferred embodiments of the present invention will be described herein. The explanation provided herein merely illustrates the embodiments of the present invention, and the present invention is not limited to the below-described embodiments. The description herein is appropriately shortened and simplified to clarify the explanation. A person skilled in the art will be able to easily change, add, or modify various elements of the below-described embodiments, without departing from the scope of the present invention.

### First Embodiment

The inventors of the present invention have found that the thickness of a transparent substrate in the backlight side of a liquid crystal panel included in a semi-transmissive liquid crystal display apparatus and the emission components of backlight emitted from a backlight and entering the liquid crystal panel largely affect the display luminance of the liquid crystal display apparatus. Further, they have clarified the relationship with an aperture portion diameter for obtaining enough reflected luminance in outside light. The present invention aims at improving display luminance of a semi-transmissive liquid crystal display apparatus by defining these things.

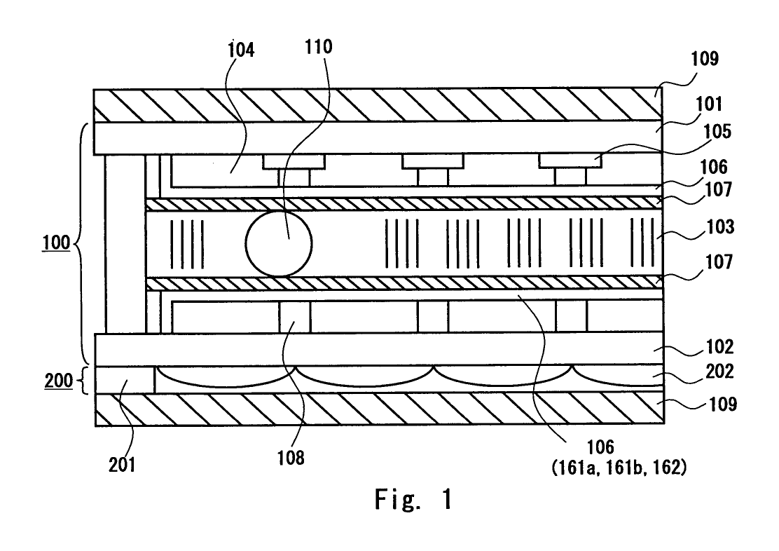

The arrangement of a microlens array in a liquid crystal display apparatus and optical effects of a microlens array are described first. FIG. 1 is a sectional view of a liquid crystal display apparatus according to a first embodiment of the invention. The liquid crystal display apparatus of the first embodiment is a so-called semi-transmissive liquid crystal display apparatus. The liquid crystal display apparatus of FIG. 1 has a liquid crystal panel 100 and a microlens array 200. In the liquid crystal panel 100, a liquid crystal layer 103 is interposed between a pair of transparent substrates 101 and 102. Though the thicknesses of the two transparent substrates 101 and 102 is 500 μm and the thickness of the liquid crystal layer 103 and so on interposed therebetween is about 6 μm, FIG. 1 illustrates them with a different scale.

The transparent substrates 101 and 102 are made of a glass, polycarbonate, acrylic resin, for example. A color filter 104 is formed in the back side, which is the side to the liquid crystal layer 103, of the transparent substrate 101 placed in the front side of the liquid crystal panel 100. The color filter 104 is composed of three areas to display red (R), green (G), blue (B), for example. A black matrix 105 is a light-shielding film that is placed between pixels in the color filter 104 to avoid light leakage between pixels so as to allow the color of each pixel to be distinctive.

A transparent electrode 106 and an alignment film 107 are sequentially deposited between the color filter 104 and the liquid crystal layer 103. The transparent electrode 106 is formed of a transparent conductive thin film (ITO; Indium Tin Oxide) by photolithography, for example. The alignment film 107 is formed of an organic thin film such as a polyimide thin film as polymeric material, for example. The alignment film 107 aligns liquid crystal molecules of the liquid crystal layer 103 in a predetermined direction. On the transparent substrate 102 placed in the backside of the liquid crystal panel 100, a TFT 108 is formed and further the transparent electrode 106 and the alignment film 107 are sequentially deposited. The TFT 108 is a switching device for driving liquid crystals. A pixel electrode 161 and a wiring 162 are formed on the transparent electrode 106 closer to the TFT 108. The pixel electrode 161 includes an aperture portion 161a and a reflecting portion 161b.

The polarizing plate 109 is an optical member that allows only a particular polarization component of incident light to pass through. The polarizing plate 109 is adhered onto the outer surfaces of the two transparent substrates 101 and 102. A spacer 110 is a resin particle to control a height (cell gap) of the liquid crystal layer 103 between the transparent substrates 101 and 102. A plurality of spacers 110 are placed in scatter formation entirely between the transparent substrates 101 and 102.

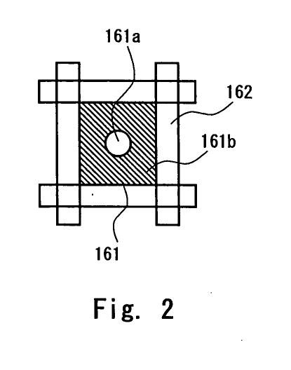

Referring next to FIG. 2, the pixel electrode 161 has the aperture portion 161a and the reflecting portion 161b. The matrix wiring 162 includes a scan line and a signal line that are orthogonal to each other. In this embodiment, the pitch of the wiring 162 is 100 μm and the width of the wiring 162 is 26 μm.

The light incident on the liquid crystal panel 100 through the transparent substrate 102 passes through the aperture portion 161a. Thus, the aperture portion 161a allows the backlight to enter the liquid crystal layer. The reflecting portion 161b serves as a reflecting plate to reflect the light entering through the transparent substrate 101. The reflecting portion 161b is formed in a part of the transparent electrode 106, and the rest of the transparent electrode 106 serves as the aperture portion 161a.

Since the aperture portion 161a allows the backlight coming from the back side to pass through, it is possible to brighten image display. The aperture portion 161a, on the other hand, cannot reflect the light coming from the front side. Therefore, a larger size of the aperture portion 161a decreases the efficiency of using the reflected light while increasing the efficiency of using the backlight. Thus, it is difficult to increase the backlight use efficiency and the reflected light use efficiency at the same time. In order to obtain high use efficiency of the reflected light, the proportion of the area of the aperture portion 161a with respect to the entire area of the display part of the liquid crystal panel 100, which is referred to herein as the aperture ratio, is preferably 50% or lower and more preferably 20% or lower. The aperture ratio should not be 0% to use the backlight. In the example of FIG. 2, the diameter of the aperture portion 161a is 35 μm and the aperture ratio is 10%. In this embodiment, the microlens array 200 is formed in the backside of the transparent substrate 102 to increase backlight use efficiency.

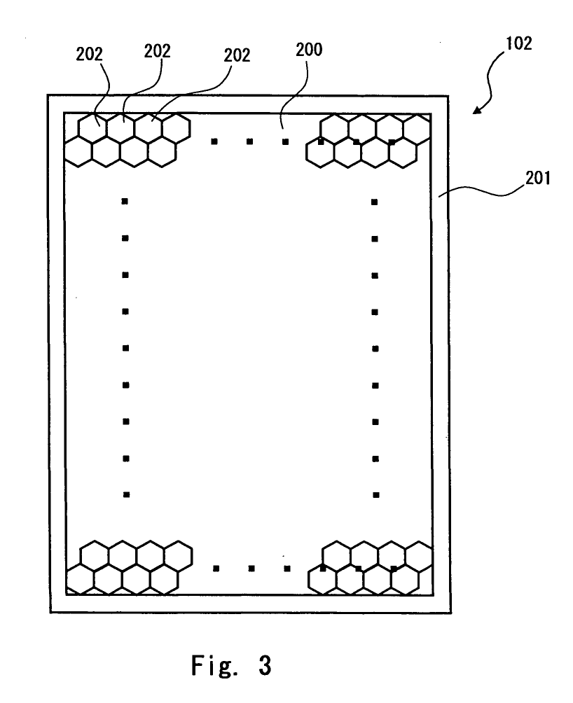

The microlens array 200 is formed in the backside of the transparent substrate 102. The microlens array 200 has a rim 201 and a microlens 202. FIG. 3 is a plan view showing the positional relationship of the transparent substrate 102, the microlens array 200 and the rim 201.

As shown in FIG. 3, the rim 201 is placed to surround a plurality of microlenses 202. The rim 201 is formed continuously along the outer circumference of the backside of the transparent substrate 102 with the same height as or higher height than the apex of the microlens 202. The rim 201 is formed in order to keep the polarizing plate 109, which is described later, while maintaining its flatness and to fix the microlens array 200 in a fabrication process, which is also described later. The rim 201 is preferably formed by the same material as the microlens 202.

Each microlens 202 has a diameter or a diagonal line of approximately 50*10⁻⁶ m and placed on a glass or synthetic resin substrate or film. The microlens 202 is formed by UV curable resin, thermoset resin or photoresist. Each microlens 202 corresponds to one pixel of the liquid crystal panel 100. In order to increase the backlight use efficiency, it is preferred that the microlenses 202 are filled with no space therebetween as shown in FIG. 3. If the bottom shape of the microlens 202 is hexagonal as shown in FIG. 3, it is possible to place the microlenses 202 without space on a flat surface. If the proportion of the area having the microlenses 202 with respect to the area of the transparent substrate 102 is a filling rate, the filling rate is at least 70% and preferably at least 80%. Besides the area of the transparent substrate 102, the filling rate can be defined by the area where backlight is applied, the area where pixels are formed in the liquid crystal panel 100, the area inside the rim 201 on the transparent substrate 102 and so on.

If backlight is applied to the liquid crystal panel 100 from the back side, a focal point of each microlens 202, which is a cross point, is located in the vicinity of the aperture portion of the black matrix 105 or the aperture portion 161a of the pixel electrode 161. Thus, the optical axis of the microlens 202 is aligned with the aperture portion 161a of the pixel electrode 161. Further, the optical axis of the microlens 202 passes through the aperture portion 161a of the pixel electrode 161, which is a different part from the TFT 108.

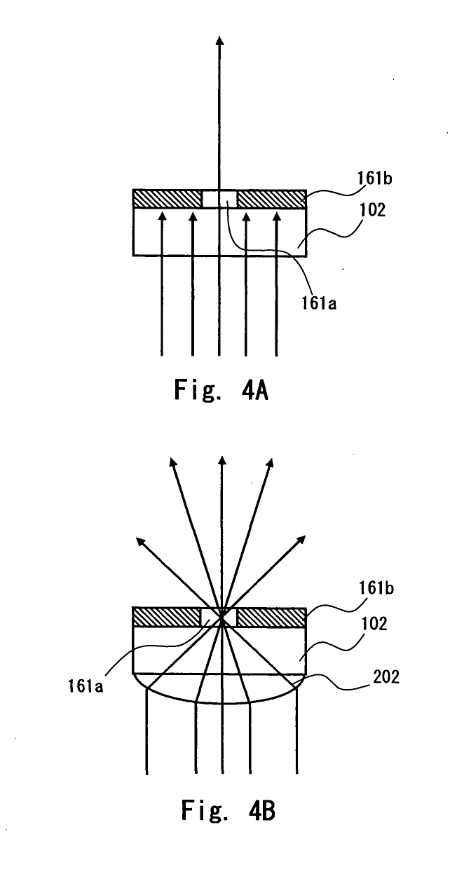

Referring then to FIGS. 4A and 4B, a difference in optical properties between the case with the microlens 202 (FIG. 4A) and the case without the microlens 202 (FIG. 4B) is described below. FIGS. 4A and 4B are schematic view of the cross section in the vicinity of the transparent substrate 102 of one pixel and the light flux passing through the same.

As shown in FIG. 4A, backlight passes through the aperture portion 161a but is reflected by the reflecting portion 161b. On the other hand, if the microlens 202 is placed as shown in FIG. 4B, since a focal point of the microlens 202 is located in the vicinity of the aperture portion 161a, the backlight is focused on the aperture portion 161a by the microlens 202 and therefore passes it through without being blocked by the wiring member. It is thereby possible to obtain high backlight use efficiency even when the aperture ratio of the aperture portion 161a is 10% or lower.

The higher the lens height of the microlens 202, the shorter the focal length is. Though the height of the microlens 202 of this embodiment is 20 μm, it may be selected according to a maximum diameter of a lens and an optimum focal length and may be selected from the range of 1 μm to 100 μm, for example. As described in the foregoing, it is preferred that the microlenses 202 are filled on the transparent substrate 102 without space so that the center of each microlens 202 is aligned with the aperture portion 161a.

### Second Embodiment

A second embodiment describes a method of fabricating a microlens array described in the first embodiment and a liquid crystal display apparatus having the microlens array. The same reference symbols as in the first embodiment designate the same or similar elements and the description is omitted.

A fabrication process of a microlens array of this embodiment includes the following steps: a first step of creating a mask pattern on a dry plate by laser lithography to form a master gray scale mask, a second step of exposing an emulsion plate through the master gray scale mask to form a mother gray scale mask, a third step of fabricating an exposure microlens on the mother gray scale mask to form a mother gray scale mask with a lens, a fourth step of expositing a photosensitive resin layer coated on the transparent substrate 102 through the mother gray scale mask with a lens to form a plurality of blocks of microlens arrays 200 on a liquid crystal substrate, and a fifth step of dividing the liquid crystal substrate with the microlens.

The master gray scale mask is a photomask to form the mother gray scale mask and has a maser pattern corresponding to a block of microlens array 200. The mother gray scale mask is used to form a plurality of blocks of microlens arrays 200. Thus, the master gray scale mask is a base of formation of the microlens array 200, and the master pattern should be highly accurate. Since mass-productivity is not required for the master gray scale mask compared to the mother gray scale mask and the microlens array 200, the master gray scale mask is formed by laser lithography that is capable of creating a highly accurate mask pattern.

The mother gray scale mask is composed of a plurality of blocks of gray scale masks to form the microlens array 200 corresponding to one liquid crystal panel 100. In each gray scale mask, a plurality of blocks of gray scales corresponding to the microlens 202 are formed. By modulating the intensity of exposure light through the gray scale, the photosensitive resin layer can be exposed into a lens shape.

The mother gray scale mask with a lens is the mask where an exposure microlens is formed corresponding to the gray scales formed on the mother gray scale mask. The exposure light whose intensity has been modulated by the gray scale is focused on the aperture portion 161a of the pixel electrode 161 formed on the transparent substrate 102 by the exposure microlens, thereby aligning the aperture portion 161a and the optical axis of the microlens 202 with high accuracy.

Each of the above steps is detailed below.

(1) First Step (Creation of a Master Gray Scale Mask)

A method of creating the master gray scale mask is described first. The master gray scale mask according to this embodiment is produced by directly creating a master pattern corresponding to the microlens 202 by laser light on a dry plate created by coating photoemulsion on a transparent substrate such as a glass and drying it and then developing the dry plate to fix it. The following description defines the patterning as creating a pattern with desired gradation on a dry plate surface while adjusting the degree of reactivity of photoemulsion contained in the dry plate by modulating the intensity of applied laser light when reacting the surface of the dry plate by applying laser light on the dry plate. By developing the dry plate having the pattern with changing reactivity, the master gray scale mask of this embodiment is produced.

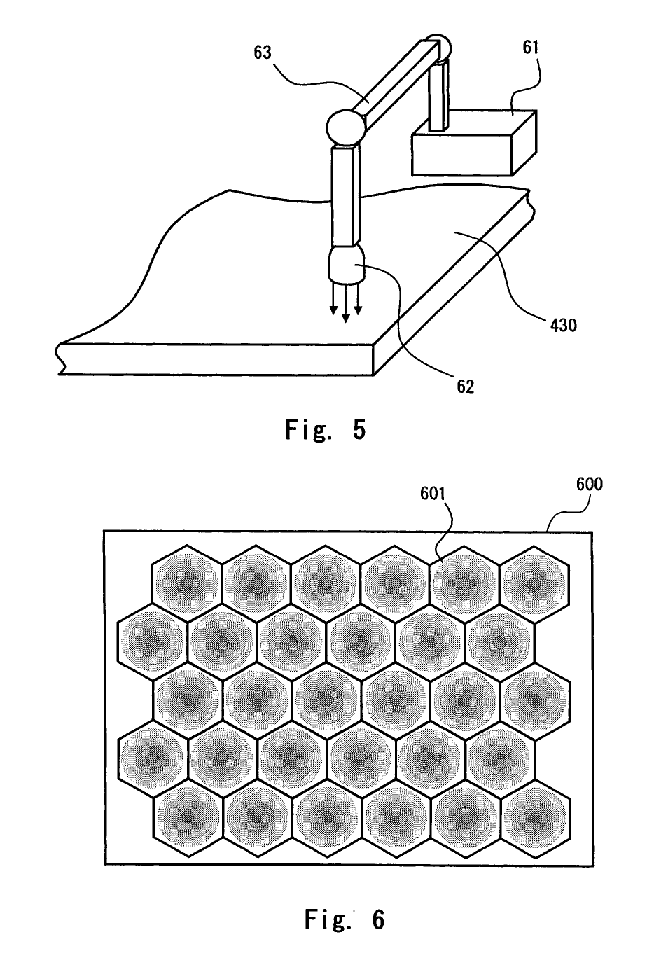

FIG. 5 is a perspective view that schematically shows creation of a pattern corresponding to the microlens 202. It shows a patterning device 60 to create a pattern on a dry plate 430. When creating the pattern corresponding to the microlens 202 on the dry plate 430, the patterning device 60 as shown in FIG. 5 is used. The patterning device 60 includes a patterning device main body 61, a light source 62 that emits laser, and an arm 63 that moves the light source 62.

The patterning device 60 is implemented by a computer and stores patterning data for creating the pattern corresponding to the microlens 202. The patterning device 60 changes the intensity and/or exposure time of the exposure light emitted from the light source 62 while moving the arm 63, thereby creating a desired pattern on the dry plate 430. The number of tones of exposure intensity modulation is from 4 to 256, for example, and preferably from 8 to 128, and more preferably from 8 to 24.

The spot diameter of the exposure light emitted from the light source 62 is 0.4 μm in this embodiment. Thus, the master pattern to be created finally has transmittance resolution of approximately 0.4 μm. After exposing the whole area of the dry plate 430 according to a programmed pattern, photoemulsion on the surface is developed and fixed, thereby completing the master gray scale mask. The process of development and fixation of the photoemulsion may use commercially available developer and fixer.

FIG. 6 shows the top view of the finished master gray scale mask 600. The master gray scale mask 600 has a master pattern 601 that corresponds to the microlens 202. By modulating the intensity of the exposure light with the master pattern 601 and exposing an emulsion plate with the modulated exposure light, it is possible to create a gray scale corresponding to the microlens 202 on the emulsion plate.

In this embodiment, the light transmittance at the outermost periphery of one master pattern 601 is substantially 100%. The light transmittance decreases concentrically towards the center of the master pattern 601 and it reaches substantially 0% at the center. The light transmittance in the area different from the part where the master pattern 601 is formed in the master gray scale mask 600 is substantially 100%. FIG. 6 illustrates that one master pattern 601 has the outline of an equilateral hexagon. This is to clarify the boundary of one master pattern, and the boundary does not exist in practice since the light transmittance at the outermost periphery of one master pattern 601 is substantially 100%.

Though FIG. 6 shows the case where one master gray scale mask 600 includes a plurality of master patterns 601, one master gray scale mask 600 may have a single master pattern 601. By creating a mask pattern with laser light, it is possible to create a highly accurate gray scale and provide a gray scale mask for optical component formation that has high productivity at low costs.

A specific fabrication process of the master gray scale mask 600 and the operation of the patterning device 60 are described below. In the vicinity of the outer periphery of the master pattern 601 that has high light transmittance, the exposure light intensity is low and/or an exposure time is short; on the other hand, in the vicinity of the center of the master pattern 601 that has low light transmittance, the exposure light intensity is high and/or an exposure time is long. It is thereby possible to create the pattern corresponding to the master pattern 601 directly on the dry plate by using laser light.

In the patterning of a dry plate by laser exposure, a pattern is either left or removed in conventional techniques. This is because such a technique is mainly used in the field of printed circuit board and an intermediate is not necessary for its application. Rather, the presence or absence of a pattern is preferably distinct in the field of printed circuit board.

In order to create a pattern where light transmittance changes in stages or in succession according to positions just like the master pattern 601, it has been necessary to use a special photosensitive plate or form a pattern by multistage exposure on resist. However, the inventors of the invention have found that it is possible to form an area with changing tones or light transmittance on a pattern to be formed on a dry plate if the exposure intensity on the dry plate is changed by adjusting the intensity of laser light to expose a dry plate in a relatively low level range.

The dry plate used in this embodiment is a transparent substrate coated with photoemulsion. The transparent substrate may be glass and and organic synthetic resin such as polyester, polyamide, polyvinyl alcohol, acrylic having transparency. The photoemulsion is emulsion having photosensitivity. This embodiment uses a dry plate such as High Resolution Plate (HE-1), which is a product of Konica Minolta Holdings, Inc. or Super Micro Photo Plate, which is a product and trademark of Fujifilm Graphic Systems Co., Ltd., for example. Use of a commercially available dry plate, not a special dry plate, allows cost reduction and productivity increase.

This embodiment uses a laser light source such as HeCd (Helium-Cadmium) laser and YAG (Yttrium-Aluminum-Garnet) laser. Since these lasers are less expensive than a high energy beam such as an electron beam that has been used conventionally, it is possible to save costs. Further, since the laser light source allows exposure in the air, it is possible to provide higher productivity than a conventional light source that requires work in vacuum. Furthermore, though a conventional light source is difficult to increase the size since there is a limit to the space that can be kept in vacuum, the laser light source of this embodiment is easy to increase the size since there is no such spatial restriction.

If a dry plate is exposed by the light source without any adjustment, the exposure intensity is so high that the emulsion on the surface is completely darkened even when the exposure intensity is modulated, thus allowing only the selection of whether a pattern is either left or removed. In order to create a pattern where the light transmittance changes gradually or continuously, it is necessary to adjust the exposure intensity so that it is as low as about 15 mW and further attenuates the exposure intensity. The exposure intensity is attenuated by using an attenuator. This embodiment attenuates the exposure intensity by placing an ND (Neutral Density) filter between a light source and an object to be exposed.

An ND filter used in this embodiment is the one where an alloy thin film of a plurality of kinds of metals is deposited on a transparent substrate by vacuum deposition, for example. The transmittance can be adjusted by changing the thickness of the metal thin film to be deposited on the transparent substrate. The ratio of the light intensity after passing through the ND filter with respect to the light intensity of a light source may be approximately 0.3*10⁻⁴ to 1.0*10⁻⁴. In this embodiment, the ratio of the light intensity after passing the ND filter with respect to the light source intensity is approximately 0.38*10⁻⁴. A metal film ND filter available from Melles Griot K.K., for example, may be used for the ND filter.

The attenuation of the light intensity by the ND filter is appropriately adjusted with respect to the light intensity of the light source. Therefore, the ND filter used in the present invention is not limited to the metal film ND filter but may be a film type ND filter if a degree of attenuation required for the ND filter is low.

It is feasible not to use the patterning device 60 that performs patterning according to patterning data to create a predetermined pattern but to move the light source 62 or the arm 63 by hand and perform exposure on the dry plate 430. In this case, the exposure intensity or exposure time may be adjusted automatically by the patterning device 60 or manually in accordance with the positions of the light source 62 and the arm 63 with respect to the dry plate 430.

The pattern to be created on the dry plate 430 is not limited to a pattern where the light transmittance gradually decreases or increases from the center toward the periphery but may be a mask pattern to create a Fresnel lens shape. Specifically, it may be a pattern where the decrease and increase in light transmittance are repeated concentrically from the center toward the periphery of the master pattern. Further, it may be a pattern to form a two-dimensional repetitive pattern such as a cylindrical lens and a triangular prism.

(2) Second Step (Creation of a Mother Gray Scale Mask)

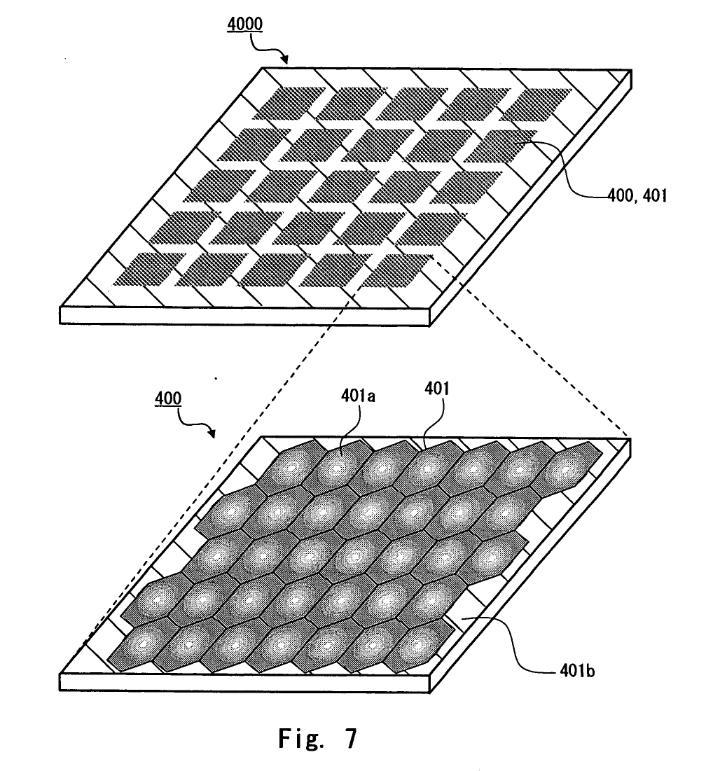

A mother gray scale mask and a method of fabricating a mother gray scale mask are described below. FIG. 7 shows a mother gray scale mask 4000. In the mother gray scale mask 4000, gray scales 400 are arranged with a certain space therebetween. One block of gray scale 400 corresponds to one block of microlens array 200 that is formed on the transparent substrate 102 of the liquid crystal panel 100.

The mother gray scale mask 4000 is composed of a plurality of blocks of gray scales 400 that are formed on the transparent substrate. The gray scale 401 that is a unit component of the gray scale 400 has a plurality of lens formation areas 401a, each corresponding to each microlens 202 to be formed finally. The lens formation areas 401a are arranged at the same pitch as the microlens 202. In an area different from the lens formation area 401a, a light shielding area 401b where light transmittance is extremely low or zero is formed.

In the lens formation area 401a, light transmittance changes continuously. Though the periphery of the lens formation area 401a is hexagonal, it may be other polygonal shapes other than hexagon, a circular shape, elliptical shape, or the like. Further, in the lens formation area 401a, the light transmittance changes concentrically and it reaches its maximum at the center of the lens formation area 401a.

In this embodiment, the light transmittance in the light shielding area 401a is 0%. In the lens formation area 401a, the light transmittance increases concentrically from the periphery toward the center, and it reaches approximately 100% at the center of the lens formation area 401a.

The emulsion plate 450 is a glass dry plate where a photoemulsion (monochrome photosensitive emulsion) is coated on a transparent substrate. The photoemulsion is exposed by the light whose intensity is modulated and then developed so that a mask pattern is created on the transparent substrate. A larger area of the emulsion plate 450 allows fabricating a larger area of the mother gray scale mask 4000, which makes it possible to form a larger number of gray scales 400 at a time.

The area of the emulsion plate 450 of this embodiment is 360 mm by 460 mm, for example. For the emulsion plate 450, High Resolution Plate (HE-1) which is available from Konica Minolta Holdings, Inc., Super Micro Photo Plate which is a trademark of and available from Fujifilm Graphic Systems Co., Ltd. and so on may be used.

The alignment substrate 500 is used to form the gray scale 400 in an accurate position on the emulsion plate 540. Since the alignment substrate 500 is superposed on the emulsion plate 450, it is preferred that the flat sizes of the alignment substrate 500 and the emulsion plate 450 are equal. The flat sizes, however, may be different as long as the position to form the gray scale 400 on the emulsion plate 450 can be adjusted.

The alignment substrate 500 has area marks 501 on its surface. The area marks 501 are arranged at a predetermined pitch on the alignment substrate 500. Each area mark 501 is a rectangular frame and it indicates the position to form one block of gray scale 401. Thus, the arrangement pitch of the area marks 501 is the same as the pitch of the gray scales 400 to be finally formed on the emulsion plate 450, which is the pitch of the gray scales 400 on the mother gray scale mask 4000.

The alignment substrate 500 is a substrate having transparency. The shape of each area mark 501 is not limited to rectangle but may be adjusted according to a block of gray scale 400. The area mark 501 does not necessarily surround the entire circumference of one gray scale 400 as long as it allows alignment of the master gray scale mask 600. The master pattern 601 formed on the master gray scale mask 600 is transferred onto the emulsion plate 450, thereby forming a lens formation area 401a.

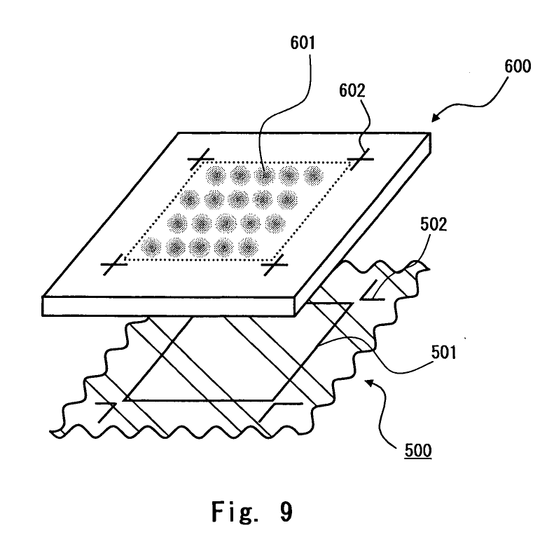

FIG. 9 is an enlarged perspective view of one area mark 501 and master gray scale mask 600. As shown in FIG. 9, alignment marks 502 are placed at the four corners of the area mark 501. The flat shape of the area mark 501 and the flat shape of the periphery of the master pattern 601 are substantially the same. Further, the position of each alignment mark 502 formed at each of the four corners of one area mark 501 and the position of each alignment mark 602 formed at each of the four corners of one master pattern 601 correspond to each other.

Since the vicinity of the area where the alignment mark 602 of the master gray scale mask 600 has transparency, it is possible to check the alignment mark 502 formed on the alignment substrate 500 through the master gray scale mask 600.

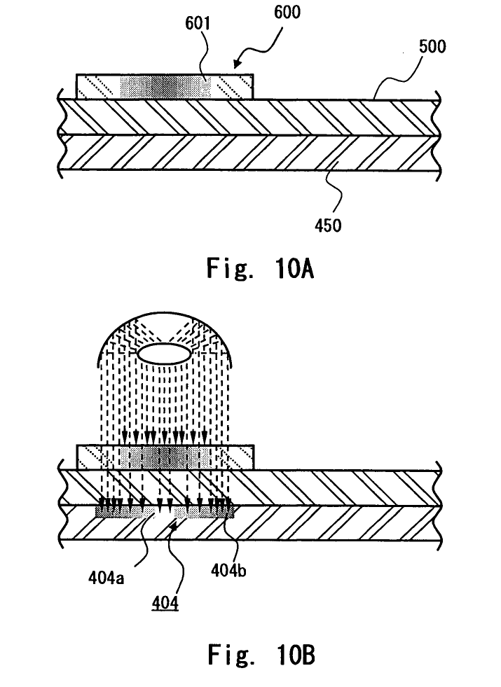

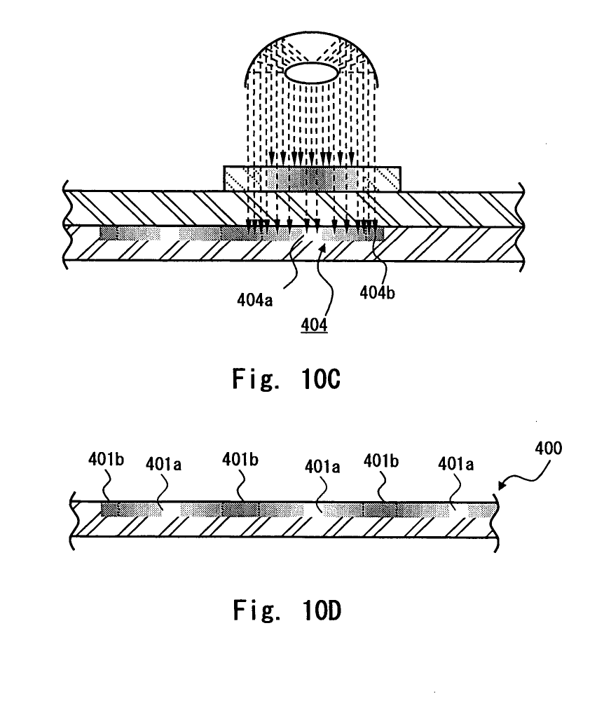

FIGS. 10A to 10D are sectional views showing the steps of the process to transfer the reversal pattern of the master pattern 601 onto the emulsion plate 450. To simplify the illustration, one master pattern 601 is created on one master gray scale mask 600 in FIG. 10; however, a plurality of master patterns 601 are created on the master gray scale mask 600 in this embodiment as shown in FIG. 6. The position is determined by aligning the alignment marks 502 and the alignment marks 602, and the alignment substrate 500 is placed on the emulsion plate 450 as shown in FIG. 1A.

The positioning may be performed not by using the alignment marks 502 and the alignment marks 602 but by using the area mark 501 and the master pattern 601. Thus, the area mark 501 and the master pattern 601 may be aligned without making the alignment marks 502 and the alignment marks 602.

Then, as shown in FIG. 10B, the emulsion plate 450 is exposed through the master gray scale mask 600. In this exposure, vertically polarized UV light with the wavelength of about 365 nm is applied at the energy of 100 mJ. The exposure range is the same as or larger than the master pattern 601. In this embodiment, the exposure light is applied to a rectangular area that is 1 mm larger than the master pattern 601 in both lengthwise and crosswise directions. The dotted lines in FIG. 10B indicate light rays of the exposure light. As shown by the dotted lines, the exposure light applied through the master gray scale mask 600 changes its intensity by the master pattern 601 and passes through the inside and vicinity of the area mark 501 to expose the emulsion plate 450.

Since the intensity of the exposure light to expose the emulsion plate 450 is changed by the master pattern 601, the emulsion plate 450 is exposed at the intensity corresponding to the pattern of the mask pattern 601. Thus, the exposure intensity is low at the position corresponding to the center of the master pattern 601 and increases concentrically toward the periphery of the master pattern 601, and the exposure intensity reaches its highest at the outermost periphery. On the exposed surface of the emulsion plate 450, the photoemulsion coated on the surface reacts to the exposure and reduces its transparency according to the exposure intensity.

As a result, a transferred pattern 404 corresponding to the reversal pattern of the master pattern 601 is created on the transparent substrate of the emulsion plate 450 as shown in FIG. 10B. In the transferred pattern 404, a transferred pattern 404a that is formed by the exposure light which has passed through the mater pattern 601 is an area formed by the exposure light whose intensity changes concentrically. Further, in the transferred pattern 404, a transferred pattern 404b that is formed by the exposure light which has passed through the outside of the master pattern 601 is an area exposed at the highest intensity. Since FIG. 10 shows one master pattern 601 for one master gray scale mask 600 as described above, one transferred pattern 404 is formed for one master gray scale mask 600. In practice, however, the same number of transferred patterns 404 as the master patterns 601 included in one master gray scale mask 600 are formed.

After exposing one area mark 501, the positioning is performed for the next area mark 501 also by aligning the alignment marks 502 and the alignment marks 602, and the emulsion plate 450 is exposed through the master gray scale mask 600 as shown in FIG. 10C, thereby crating another transferred pattern 404. Exposure areas contact or overlap with each other so that the adjacent exposure areas are continuing.

As described above, the exposure is repeated on all the area marks 501, thereby creating the transferred patterns 404 on the emulsion plate 450 at the same pitch as the pitch of the area marks 501 on the alignment substrate 500. After completing the exposure on all the area marks 501, the emulsion plate 450 is developed so as to fix the transferred patterns 404a as the lens formation areas 401a and the transferred patterns 404b as the light shielding areas 401b as shown in FIG. 10b. The mother gray scale mask 4000 having the gray scales 400 is thereby completed.

In this way, by exposing each area mark 501 by aligning the master gray scale mask 600 using the alignment substrate 500, it is possible to form the lens formation areas 401a and the light shielding areas 401b highly accurately on the whole surface of the emulsion plate 450. Further, use of the alignment substrate 500 eliminates the need for making alignment mark such as the alignment mark 502 on the emulsion plate. This allows the use of a commercially-available photosensitive plate, not a special photosensitive plate, thus achieving high productivity. This fabrication method can provide a large gray scale mask 400 and mother gray scale mask 4000 where a predetermined mask pattern is created at a predetermined pitch with high accuracy at low costs.

The transmittance distribution of the lens formation area 401a formed as above is described herein. If the coordinates of the plane perpendicular to the optical axis of the light having passed through the lens formation area 401a are represented by x and y whose origin is the center of the lens formation area 401a, and the light intensity distribution on the plane perpendicular to the optical axis of the light having passed through the lens formation area 401a is represented by Z, the light intensity Z satisfies the conditions of:

$$\begin{matrix}Z = k - {\sum }_{n = 1}^{m} {C}_{n} {h}^{2 n} & ( 1 ) \\ h = {( {x}^{2} + {y}^{2} )}^{1 / 2} \\ n = 1 , 2 , 3 , 4 , ⋯ & ( 2 )\end{matrix}$$

where Cₙ is a given real number, m is a given natural number, and k is zero or a given positive real number.

In the above expressions, k represents the light intensity after passing through the lens formation area 401a at the origin of y-coordinate or the center of the lens formation area 401a. h represents a distance from the origin as shown in the expression (2). The second term in the expression (1), which is a minus term, is a sum of the term with the coefficient of C₁ to the term with the coefficient of Cₘ as shown in the expression (1). Cₙ represents the coefficient in the term corresponding to each n. For example, if Z=k−C₁h², m=1 and if Z=k−(C₁h²+C₂h²+C₃h²), m=3.

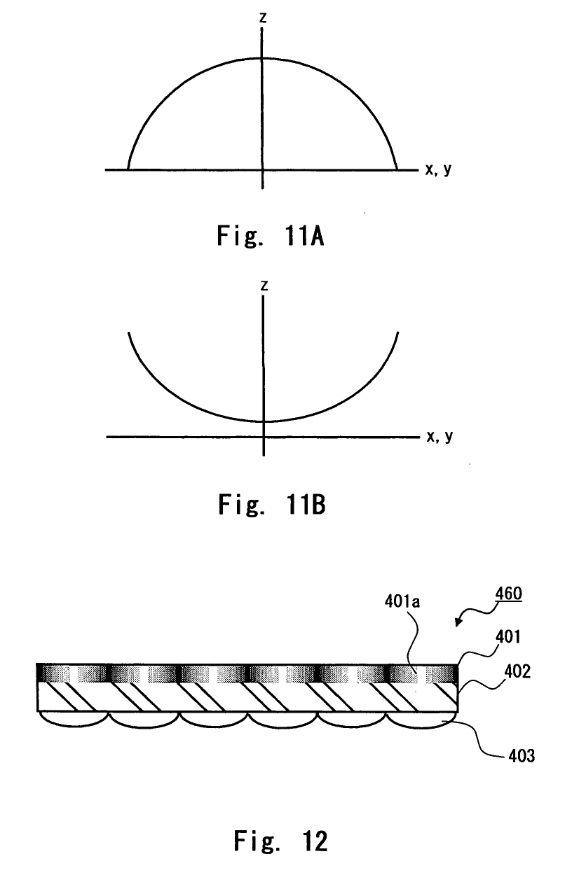

The expression (1) depends on h directly, and it represents the correlation between the distance h from the origin and the light intensity Z after passing through the lens formation area 401a. Thus, since the value of Z is determined by the distance h from the center of the lens formation area 401a, the light intensity Z changes concentrically from the origin. If the value of Cₙ is all positive in the expression (1), an absolute value of the minus term increases as it gets farther from the origin. Thus, the light intensity Z becomes lower as it gets farther from the origin or the lens optical axis. This is the condition of the exposure light intensity in this embodiment. The exponentiation of h is the power of 2n, which is an even number, indicating that the value related to the light intensity Z is symmetric to the origin. Further, by the exponentiation, the rate of the change of the power increases as it gets farther from the origin. Therefore, the light intensity Z can be distributed in a convex lens shape whose optical axis is at the origin as shown in FIG. 11A.

On the other hand, if the microlens to be fabricated is concave-shaped, the light transmittance of the lens formation area 401a is lowest at the center and highest at the outermost periphery. This condition is achieved if the value of Cₙ is all negative in the expression (1). The light intensity Z can be thereby distributed in a concave lens shape whose optical axis is at the origin as shown in FIG. 11B. The graphs shown in FIGS. 11A and 11B are not continuous because the light intensity Z is calculated for each lens formation area 401a. Thus, the values of x and y are finite values from the center of the lens formation area 401a to the outer periphery of the unit mask.

By defining the light intensity Z in this way, it is possible to form a desired lens shape by adjusting the values of Cₙ and m. The expression (1) indicates that the light intensity Z depends on the distance h from the origin or the lens optical axis, and it is not limited to simple increase or decrease as shown in FIG. 11. Since Cₙ is a constant that does not depend on n and that can be set for each value of n, it is also possible to set the extreme value of the light intensity Z at the point that is not the lens optical axis nor the lens outermost periphery by setting each value of Cₙ independently. Further, Cₙ may be a function of n.

(3) Third Step (Creation of a Mother Gray Scale Mask with Lens)

A mother gray scale mask with lens and a method of fabricating the mother gray scale mask with lens are described below. FIG. 12 is a sectional view of the mother gray scale mask with lens 460 according to this embodiment. The mother gray scale mask with lens 460 has the gray scale 401 on one surface of a supporting substrate 402 and an exposure microlens 403 on the other side surface. Thus, in this embodiment, the exposure microlens 403 is formed on the opposite surface from the surface where the gray scale 401 of the mother gray scale mask 4000 is formed in alignment with the gray scale 401.

When forming the microlens 202 by using the mother gray scale mask with lens 460, a photosensitive resin layer is exposed into a lens shape by exposure light whose intensity is modulated and then hardened. This embodiment focuses the exposure light on the aperture portion 161a by getting around the TFT and the reflecting portion 161b of the pixel electrode 161 formed on the transparent substrate 102 of the liquid crystal panel 100, thereby forming the microlens 202 directly on the transparent substrate 102 while aligning the aperture portion 161a with the optical axis of the microlens 202. The mother gray scale mask with lens 460 has a function to modulate the intensity of exposure light and a function to focus the exposure light on the aperture portion of a circuit element.

Though this embodiment forms the gray scale 401 and the exposure microlens 403 on the opposite sides of the supporting substrate 402, the present invention is not limited thereto. For example, it is feasible to form the gray scale 401 on the supporting substrate 402 and further form the exposure microlens 403 on the gray scale 401. It is also feasible to form the exposure microlens 403 on the supporting substrate 402 and further form the gray scale 401 on the exposure microlens 403.

In the structure of FIG. 12, the exposure light enters through the gray scale 401. The supporting substrate 402 is a transparent substrate such as a glass, polycarbonate, and acrylic resin. This embodiment forms the mother gray scale mask 4000 by exposing the emulsion plate 450 that is a transparent substrate coated with photoemulsion, and the transparent substrate of the mother gray scale mask 4000 corresponds to the supporting substrate 402.

As described above, the gray scale 401 is composed of the hexagonal lens formation areas 401a. In the lens formation areas 401a, light transmittance continuously changes concentrically from the center toward the periphery. In this embodiment, the light transmittance is highest (for example, 100%) at the center of the lens formation area 401a and lowest (for example, 0%) at the outermost periphery. The highest and lowest transmittance of the lens formation area 401a are not limited to 100% and 0%, respectively. The transmittance is appropriately adjusted in the range of the highest transmittance of 80% or higher and preferably 90% or higher and the lower transmittance of 20% or lower and preferably 10% or lower.

The exposure light changes its intensity by passing through such a mask pattern. Thus, exposing photocurable resin with this exposure light allows hardening the photocurable resin in a lens shape. Thus, the peripheral shape and the transmittance distribution of the lens formation area 401a are reflected in the shape of the microlens 202. The peripheral shape of the lens formation area 401a may not be hexagonal but be circular, elliptical, or polygonal other than hexagonal. For example, the shape of a pixel in a display used for a television or the like is generally rectangle with the horizontal to vertical ratio of 3:1, and the shape of a microlens is preferably also rectangle with the horizontal to vertical ratio of 3:1 just like the pixel shape. Even if the lens formation area 401a has a shape other than hexagon, the light transmittance continuously changes concentrically from the center.

The exposure microlens 403 is formed by photocurable resin and specifically negative photoresist. It is possible to form the exposure microlens 403 by positive resist, thermosetting resin, thermoplastic resin and so on. However, since the exposure microlens 403 is used as an optical lens, the material is preferably not photodegradable or thermoplastic. Further, forming the exposure microlens 403 by thermosetting resin requires heat treatment in the formation of the exposure microlens 403, which heats other components and can cause deformation or transformation. Therefore, it is preferred that the material of the exposure microlens 403 is negative photoresist. Another reason to use the negative photoresist as the material of the exposure microlens 403 relates to an alignment accuracy between the gray scale 401 and the exposure microlens 403. This is described later.

The exposure microlens 403 is composed of hexagonal unit lenses. The flat shape of the unit lens and the flat shape of the lens formation area 401a are substantially the same. Thus, the lens formation area 401a and the unit lens are arranged in the same pitch. Further, the center of the lens formation area 401a and the optical axis of the unit lens are substantially the same. Thus, if the exposure light is vertically polarized light, the exposure light whose intensity is modulated by the same lens formation area 401a is focused by the unit lens that is aligned with this lens formation area 401a. Though the unit lens included in the exposure microlens 403 may not be hexagonal such as circular or elliptical, a hexagonal shape is preferred in consideration of a filling rate on the flat surface. Further, the unit lens is preferably the same shape as the lens formation area 401a in order to increase the shape accuracy of the microlens to be formed.

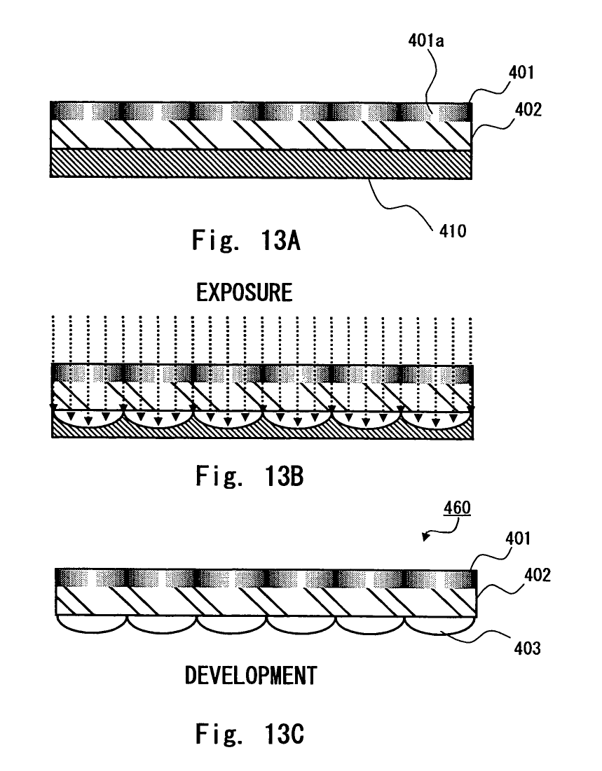

A method of fabricating the mother gray scale mask 460 according to this embodiment is described with reference to FIG. 13. First, a negative photoresist layer is coated on one surface of the mother gray scale mask with lens 460. Thus, as shown in FIG. 13A, the negative photoresist layer 410 is coated on the surface of the supporting substrate 402 opposite from the surface where the gray scale 401 is formed. The supporting substrate 402 and the gray scale 401 constitute the mother gray scale mask 4000. The negative resist layer 410 is UV curable photoresist, for example, such as photosensitive sol-gel resin that is transparent and UV curable. The photosensitive sol-gel resin may contain fluorine, metal particle, complex and so on.

Then, the negative resist layer 410 is exposed to light through the gray scale 401 as shown in FIG. 13B. In this exposure, UV light with the wavelength of about 365 nm is applied at the energy of 3000 mJ. The dotted lines in FIG. 13B indicate light rays of the exposure light. As shown by the dotted lines, the exposure light applied through the gray scale 401 changes its intensity by the gray scale 401. Specifically, the light intensity is modulated concentrically so that it is highest at the center of the lens formation area 401a.

The exposure light whose intensity is modulated by the lens formation area 401a passes through the supporting substrate 402 to expose the negative resist layer 410. Since the exposure light is intensity-modulated by the lens formation area 401a, the light having passed through the center of the lens formation area 401a has a high intensity while the light having passed through the periphery of the lens formation area 401a has a low intensity. It is thereby possible to expose the negative resist layer 410 in a lens shape as shown in FIG. 13B.

After the exposure, the negative resist layer 410 is developed to remove an uncured part. This produces the mother gray scale mask with lens 460 as shown in FIG. 13C. The optical axis of each unit lens of the exposure microlens 403 vertically corresponds to the center of each lens formation area 401a. Therefore, it is possible to facilitate the alignment of the gray scale 401 and the exposure microlens 403 by forming the exposure micro lens 403 with photocurable resin such as the negative resist layer 410. Further, since it allows one-shot exposure, it is possible to form a large number at the same time on a large area, providing high productivity.

Since the exposure microlens 403 is formed on the mother gray scale mask 4000 in the above description, the mother gray scale mask with lens 460 is composed of plurality of gray scale masks 400 to form a microlens array 200 included in one liquid crystal panel 100. If the exposure microlens 403 is formed on one gray scale mask 400, it produces a gray scale mask with lens to form a microlens array 200 included in one liquid crystal panel 100.

(4) Fourth Step (Creation of a Plurality of Blocks of Microlens Arrays on a Liquid Crystal Substrate)

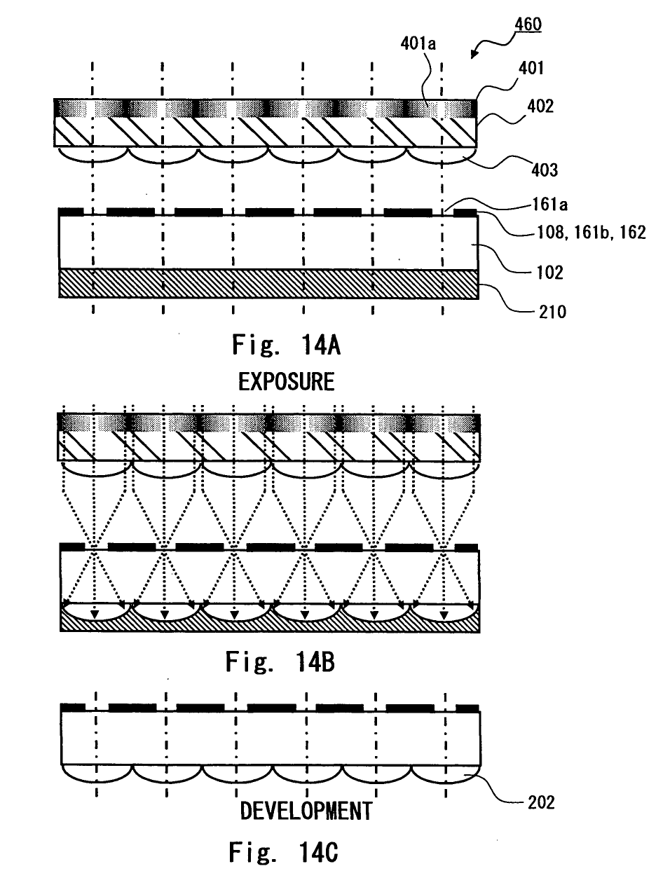

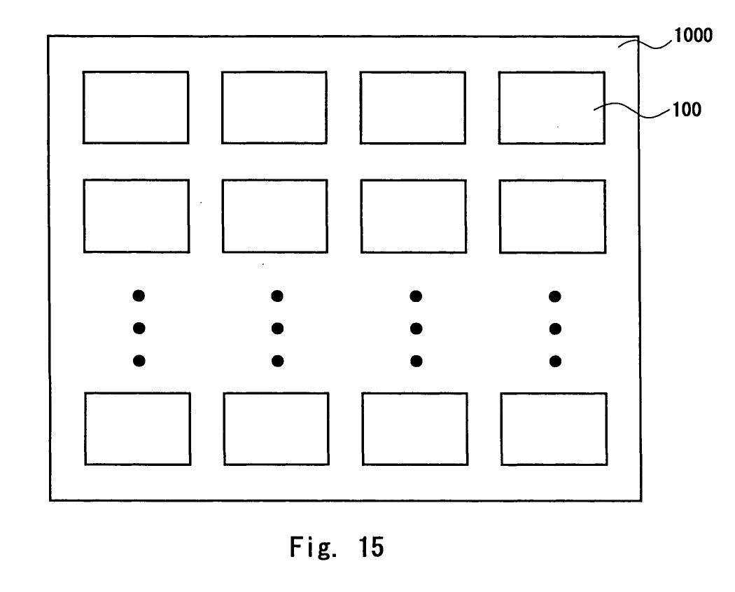

A method of fabricating the microlens array 200 on a liquid crystal substrate by using the mother gray scale mask with lens 460 is described herein with reference to FIGS. 14A to 14C.

As shown in FIG. 14A, a negative resist layer 210 is coated on one surface of the transparent substrate 102 that is a substrate of the liquid crystal panel 100. The negative resist layer 210 may be the same as or different from the negative resist layer 410 of FIG. 13 as long as it is transparent and UV-curable. On the other surface of the transparent substrate 102, a TFT 108, pixel electrode 161 and wiring 162 are formed.

As shown in FIG. 14A, the mother gray scale mask with lens 460 and the transparent substrate 102 are arranged so that the surface with the TFT 108 and the exposure micro lens 403 face each other. As indicated by the dashed lines in FIG. 14A, the center of the lens formation area 401a and the optical axis of the unit lens of the exposure microlens 403 pass through the aperture portion 161a. Thus, they are arranged so that the pitch of the lens formation area 401a and the unit lens of the exposure microlens 403 correspond to the pitch of the aperture portion 161a. Further, they are arranged so that a distance between the exposure microlens 403 and the surface having the TFT 108 or the like is substantially the same as a focal length of the exposure microlens 403. The mother gray scale mask with lens 460 and the transparent substrate 102 are arranged so that the exposure light focused by the exposure microlens 403 can pass through the aperture portion 161a without being blocked by circuit devices.

Then, as shown in FIG. 14B, the negative resist layer 210 is exposed to parallel light through the gray scale 401 of the mother gray scale mask with lens 460. In this exposure, UV light with the wavelength of about 365 nm is applied at the energy of 3000 mJ. The dotted lines in FIG. 14B indicate light rays of the exposure light. As shown by the dotted lines, the exposure light applied through the gray scale 401 changes its intensity by the lens formation area 401a. Specifically, the light intensity is modulated so that it is highest at the center of the lens formation area 401a and concentrically decreases toward the periphery.

The exposure light whose intensity is modulated by the lens formation area 401a passes through the supporting substrate 402 to enter the exposure microlens 403. As described above, the exposure light whose intensity is modulated by the same lens formation area 401a enters the corresponding unit lens. The exposure light focused by the exposure microlens 403 passes through the aperture portion 161a without being blocked by the TFT 108 and the reflecting portion 161b and enters the transparent substrate 102.

After passing through the aperture portion 161a, the exposure light passes through the transparent substrate 102 to expose the negative resist layer 210. Since the exposure light is intensity-modulated by the lens formation area 401a, the light having passed through the center of the lens formation area 401a has a high intensity while the light having passed through the periphery of the lens formation area 401a has a low intensity. It is thereby possible to expose the negative resist layer 210 in a lens shape as shown in FIG. 14B. The optical distance of the focal length of the exposure microlens 403 in the air and the thickness of the transparent substrate 102 are preferably the same. In other words, the optical path length inside the transparent substrate 102 and the optical path length from the exposure microlens 403 to the TFT 108 in the air are preferably the same. The spread of the light to expose the negative resist layer 210 is thereby the same as the flat shape of the unit lens of the exposure microlens 403. Therefore, if the exposure microlenses 403 are filled on the supporting substrate 402 without any space therebetween, it is possible to form the microlenses without space by exposing the negative resist layer 210.

Even if the adjacent unit lenses are spaced from each other in the exposure microlens 403, it is possible to form the microlenses 202 without space by adjusting the thickness or refractive index of the transparent substrate 102 or the optical path length in the transparent substrate 102.

After the exposure, the negative resist layer 410 is developed to remove an uncured part. This produces the mother gray scale mask with lens 460 as shown in FIG. 13C. The optical axis of each unit lens of the exposure microlens 403 thus fabricated vertically corresponds to the center of each lens formation area 401a. Therefore, it is possible to facilitate the alignment of the gray scale 401 and the exposure microlens 403 by forming the exposure micro lens 403 with photocurable resin such as the negative resist layer 410. Further, since it allows one-shot exposure, it is possible to form a large number at the same time on a large area, achieving high productivity.

Though the exposure light is intensity-modulated by the mother gray scale mask with lens 460 and focused on the aperture portion 161a in the above description, the gray scale 401 and the exposure microlens 403 may be different parts. The invention is not limited to the above-described way as long as parallel light corresponding to the shape of the microlens 202 can be focused on the aperture portion 161a.

(5) Fifth Step (Cutoff of the Liquid Crystal Substrate Having Microlenses)

On the transparent substrate 102 on which the microlenses 202 are formed in the above process, other components as shown in FIG. 1 are formed, thereby producing the liquid crystal panel 100 where the microlens array 200 and the aperture portion 161a of the pixel electrode 161 are accurately aligned.

Specifically, the components as shown in FIG. 1 are formed on a large substrate on which a plurality of transparent substrates with the microlenses are formed continuously. This produces a large mother substrate 1000 where the liquid crystal substrates 100 are arranged with a certain space therebetween. In each liquid crystal panel 100, the components are placed between the transparent substrate 101 and the transparent substrate 102 on which the microlenses are formed by the fabrication method of this invention. The mother substrate 1000 is finally divided into pieces, thereby providing a number of liquid crystal panels 100.

As described in the first to fifth steps, the fabrication method of the microlens array according to the second embodiment provides a microlens array and a liquid crystal display apparatus that allow alignment of the optical axis of the microlens array and have high productivity.

Further, by using the mother gray scale mask with lens as described above, it is possible to facilitate the optical axis alignment in the fabrication process of the microlens array and provide the microlens array with high productivity.

Though this embodiment forms the exposure microlens 403 by coating the negative resist layer 410 on the opposite surface of the gray scale 401, it is feasible to form the negative resist layer 410 directly on the gray scale 401 and apply exposure light from the opposite surface of the gray scale 401, thereby forming the exposure microlens 403. The structure is not particularly limited as long as the exposure light whose intensity is modulated by the lens formation area 401a is focused by the exposure microlens 401.

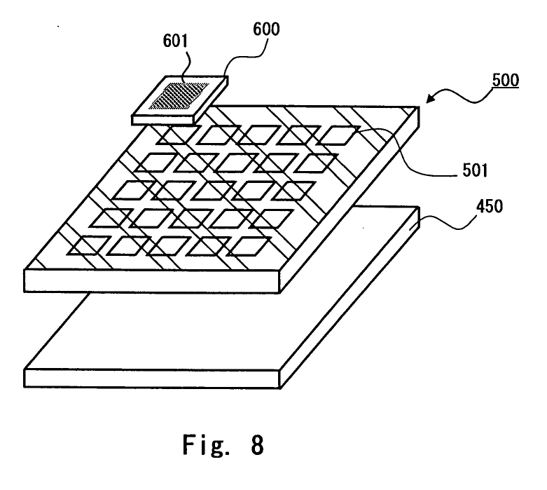

Further, the method of fabricating the gray scale mask according to this embodiment described with reference to FIGS. 8 and 9 allows providing a large gray scale mask where a predetermined mask pattern is accurately arranged at a predetermined pitch with low costs.

Furthermore, the method of fabricating the master gray scale mask according to this embodiment described with reference to FIG. 5 allows forming an accurate gray scale and providing a gray scale mask for optical component formation with low costs and high productivity.

Though the above description uses the mask created by laser patterning as the master gray scale mask 600, it is feasible to use the mask created by laser patterning as the gray scale mask 400 or the mother gray scale mask 4000.

### Third Embodiment

A third embodiment of the present invention describes modified steps of the first and second steps of the second embodiment. Though the second embodiment describes the method of forming a convex-shaped microlens 202 on the transparent substrate 102, this embodiment describes the method of forming a concave-shaped microlens 202 on the transparent substrate 102.

This embodiment uses a gray scale mask that has a different transmittance pattern from the gray scale mask 400 used in the second embodiment. The light transmittance is highest at the periphery of the lens formation area 401a and it changes concentrically in the lens formation area 401a until it reaches its lowest at the center of the lens formation area 401a.

In this embodiment, the light transmittance in the area corresponding to the light shielding area 401b of FIG. 8, which is referred herein as the transmitting area 401c, is substantially 100%. In the lens formation area 401a, the light transmittance decreases concentrically from the periphery to the center, and it reaches substantially 0% at the center of the lens formation area 401a.

If the mother grayscale mask with lens 460 is fabricated by using the mother gray scale mask 400 where such a gray scale mask 400 is formed and then the microlens array is formed by the method described in the second embodiment, a convex-shaped lens can be formed. Further, when using positive resist, not negative resist, it is feasible to form a convex-shaped lens by exposing the negative resist layer 210 through the mother gray scale mask with lens 460 from the opposite direction of the second embodiment.

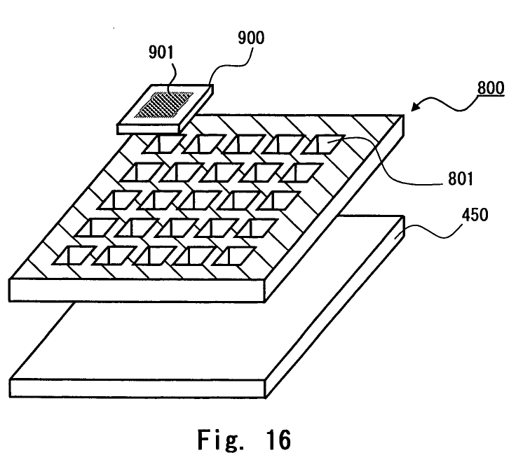

A method of fabricating the gray scale mask 400 and the mother gray scale mask 4000 is detailed herein with reference to FIG. 16. An alignment substrate 800 is placed on an emulsion plate 450, and a master gray scale mask 900 is placed on the alignment substrate 800.

The alignment substrate 800 of this embodiment has rectangular perforated portions 801. The perforated portions 801 are arranged at a predetermined pitch on the alignment substrate 800. Exposure light passes through the perforated portion 801 when forming a gray scale on the emulsion plate 450. The arrangement pitch of the perforated portions 801 is the pitch of the gray scale masks 400 to be formed on the emulsion plate 450. The alignment substrate 800 is a light-shielding substrate with the light transmittance of 0%. The shape of the perforated portion 801 is not limited to rectangle but may be altered according to the gray scale 400 included in one gray scale mask 400 to be formed.

The master gray scale mask 900 is a mask having a master pattern 901 capable of transferring the mask pattern of a gray scale. The master pattern 901 is an area where light transmittance changes continuously on the master gray scale mask 900. The peripheral shape of the master pattern 901 of this embodiment is hexagonal. The transmittance changes concentrically within the area of the master pattern 901 and reaches its highest at the center. The periphery of the area where a plurality of master patterns 901 are formed has substantially the same shape as the perforated portion 801 that is formed on the alignment substrate 800. In the master gray scale mask 900, the area where the master pattern 901 is not formed is transparent.

In this embodiment, the light transmittance is 0% at the outermost periphery of the master pattern 901. The light transmittance increases concentrically toward the center of the master pattern 901 and it reaches substantially 100% at the center. Further, the area of the master gray scale mask 900 where the master pattern 901 is not formed has a transmittance of substantially 100%.

Though the master gray scale mask 900 of this example corresponds to one gray scale mask 400, it may correspond to one microlens 202, which is the one having a single master pattern 901, or may correspond to a plurality of gray scale masks 400. If the master gray scale mask 900 corresponds to one gray scale mask 400, the perforated portion 801 of the alignment substrate 800 has the shape that is the same as the peripheral shape of the gray scale mask 400.

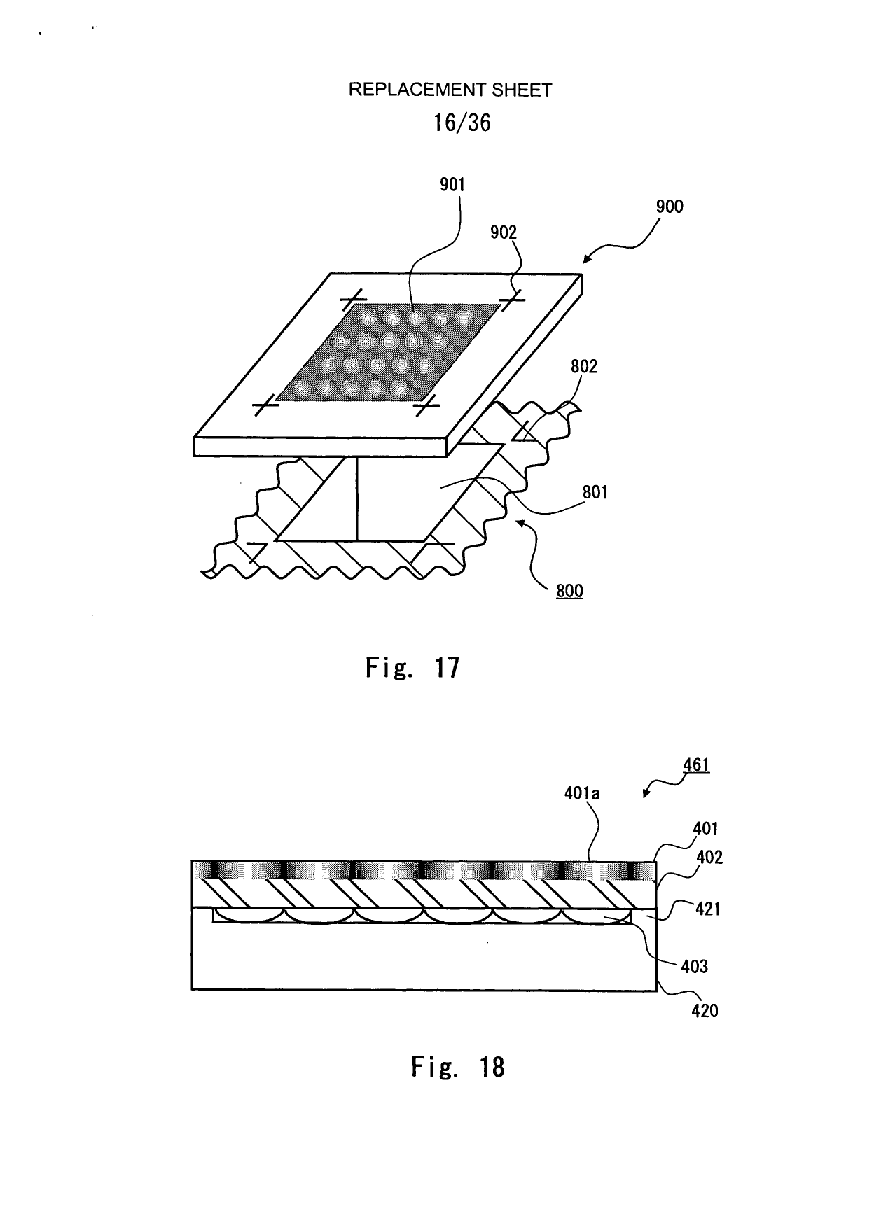

FIG. 17 is an enlarged perspective view showing one perforated portion 801 and master gray scale mask 900. As shown in FIG. 17, alignment marks 802 are made at the four corners of the perforated portion 801. Further, alignment marks 902 are made at the four corners of the master pattern 901. The position of each alignment mark 802 formed at each of the four corners of one perforated aperture 801 and the position of each alignment mark 902 formed at each of the four corners of one master pattern 901 correspond to each other.

Use of the alignment substrate 800 and the master gray scale mask 900 for exposing the emulsion plate 450 as described in FIG. 10 allows creating a gray scale mask having an opposite light transmittance pattern from the gray scale mask 400 of the third embodiment. Thus, the exposure light applied through the master gray scale mask 900 is intensity-modulated by the master pattern 901 and then passes through the perforated portion 801 to expose the emulsion plate 450.

Since the exposure light to expose the emulsion plate 450 is intensity-modulated by the master pattern 901, it exposes the emulsion plate 450 at the intensity according to the reversal pattern of the master pattern 901. The exposure intensity is high at the position corresponding to the center of the master pattern 901 and decreases concentrically toward the periphery of the master pattern 901 until it reaches 0 at the outermost periphery of the master pattern 901. The exposure intensity is 0 at the position corresponding to the outside of the perforated portion 801 of the alignment substrate 800 since the exposure light is blocked by the alignment substrate 800.

As a result, a transferred pattern corresponding to the reversal pattern of the master pattern 901 is created on the position corresponding to the perforated portion 801 on the emulsion plate 450. After exposing one perforated portion 801, the alignment marks 802 and the alignment marks 902 are aligned for the next perforated portion 801 and the emulsion plate 450 is exposed through the master gray scale mask 900, thereby crating another transferred pattern.

As described above, the exposure is repeated on all the perforated portions 801, thereby creating a transferred pattern on the emulsion plate 450 at the same pitch as the pitch of the perforated portion 801 on the alignment substrate 800. After completing the exposure on all the perforated portions 801, the emulsion plate 450 is developed so as to fix the transferred pattern as the lens formation area 401a. In the area where the exposure light is blocked, a pattern is fixed as the transmitting area 401c that corresponds to the light shielding area 401b in the third embodiment. The gray scale mask is thereby completed. By creating the master pattern 901 of the master gray scale mask 900 where the light transmittance decreases continuously from the center to the periphery, it is possible to produce a gray scale mask having the lens formation area 401a where the light transmittance gradually increases from the center to the periphery.

As described above, this embodiment of the present invention can provide a gray scale mask having various patterns by adjusting the master pattern of the master mask. Though this embodiment uses the alignment substrate 800 having a rectangular perforated portion 801, it may use the alignment substrate 500 having alignment marks that is used in the second embodiment. Further, the second embodiment may use the alignment substrate 800 that is used in the third embodiment.

The master pattern of the master mask is not limited to the one where the light transmittance gradually decreases or increases from the center to the periphery. For example, it may be a mask pattern for creating a Fresnel lens shape. Specifically, it may be a pattern where the decrease and increase in light transmittance are repeated concentrically from the center toward the periphery of the master pattern. Further, it may be a pattern to form a two-dimensional repetitive pattern such as a cylindrical lens and a triangular prism.

### Fourth Embodiment

A fourth embodiment of the present invention describes a modified form of the mother gray scale mask with lens in the third step of the second embodiment. The mother gray scale mask with lens according to the fourth embodiment of the invention is the one where a position fixing function is added to the mother gray scale mask with lens of the third embodiment. The same reference symbols as in the first to fourth embodiments designate the same or similar elements and the description is omitted. FIG. 18 is a sectional view showing a mother gray scale mask with lens 461 according to this embodiment. The mother gray scale mask with lens 461 has a positioning member 420 on the surface where the exposure microlens 403 is formed.

The positioning member 420 is a transparent substrate such as a glass, polycarbonate and acrylic resin. The positioning member 420 has a projecting portion 421 whose height is the same as or higher than the lens height of the exposure microlens 403. The positioning member 420 and the supporting substrate 402 are fixed to each other when the top of the projecting portion 421 and the surface of the supporting substrate 402 are attached together. The thickness of the positioning member 420 is substantially the same as the focal length of the exposure microlens 403.

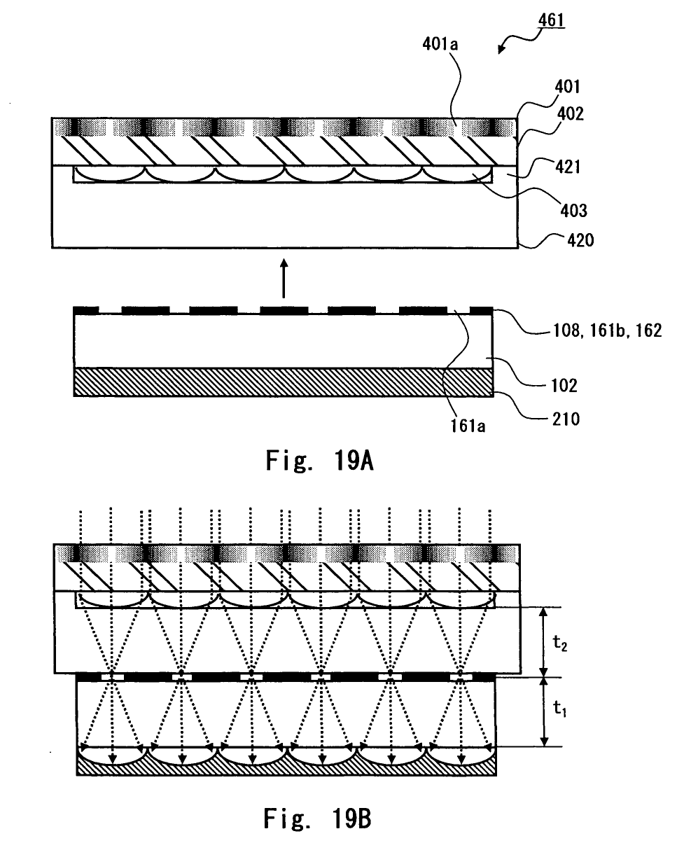

A method of fabricating the microlens 202 using the mother gray scale mask with lens 461 according to this embodiment is described herein with reference to FIGS. 19A and 19B. A negative resist layer 210 is deposited on the surface of the transparent substrate 102 which is opposite from the surface where the TFT 108 and the transparent electrode 106, which are referred to collectively as the circuit element, are formed. First, as shown in FIG. 19A, the mother gray scale mask with lens 461 and the transparent substrate 102 are contacted so that the positioning member 420 and the circuit devices face each other, and they are fixed to overlap. At this time, the center of the lens formation area 401a of the gray scale 401, the optical axis of the exposure microlens 403, and the aperture portion 161a of the circuit device are aligned.

The thickness of the positioning member 420 is substantially the same as the focal length of the exposure microlens 403. Therefore, the focal point of the exposure microlens 403 is automatically aligned with the aperture portion 161a when the positioning member 420 is aligned and superposed on the TFT 108 as shown in FIG. 19B.

In this embodiment, the thickness of the positioning member 420 (referred to hereinafter as t₂) is substantially the same as the thickness of the transparent substrate 102 (referred to hereinafter as t₁). The refractive index of the positioning member 420 (referred to hereinafter as n₂) is the same as the refractive index of the transparent substrate 102 (referred to hereinafter as n₁). Thus, the positioning member 420 has the same thickness as the transparent substrate 102 and is produced by the same material. The thickness of the circuit device is negligible for the thickness of the positioning member 420 and the transparent substrate 101. The optical axis of the unit lens included in the exposure microlens 403 corresponds to the aperture portion 161a of the circuit element formed on the transparent substrate 102. Further, the focal length of the unit lens included in the exposure microlens 403 is substantially the same as t₂. Thus, the focal point of the exposure microlens 403 is located in the vicinity of the aperture portion 161a of the circuit element.

When forming the rim 201 shown in FIGS. 1 and 3, a certain area having maximum transmittance is formed on the outermost part of the gray scale 401. If this transmittance is the same as that of the center of the circular mask pattern, the height of the microlens 202 to be patterned and the height of the rim 201 are the same.

As shown in FIG. 19B, the negative resist layer 210 is exposed to light through the gray scale 401 as shown in FIG. 19B. In FIG. 19B, the exposure light is indicated by arrows. In this exposure, UV light with the wavelength of about 365 nm is applied at the energy of 3000 mJ. The light applied through the gray scale 401 is intensity-modulated by the lens formation area 401a. Specifically, the intensity is modulated radially so that it is highest at the center of the lens formation area 401a.

The exposure light whose intensity is modulated by the lens formation area 401a enters the exposure microlens 403. As described above, the focal point of the exposure microlens 403 is aligned with the aperture portion 161a of the circuit element formed on the transparent substrate 102. The exposure light thereby enters the transparent substrate 102 without being blocked by the circuit element.

The exposure light having passed through the circuit element then passes through the transparent substrate 102 to expose the negative resist layer 210. As described above, the thickness and refractive index of the positioning member 420 are the same as the thickness and refractive index of the transparent substrate 102. Therefore, the exposure light converged near the aperture portion of the circuit element has the same diameter as the unit lens included in the exposure microlens 403 in the vicinity of the negative resist layer 210. Further, the intensity is higher as it is closer to the center of the diameter as a result of the intensity modulation by the lens formation area 401a. Thus, the negative resist layer 210 is exposed most intensely by the exposure light having passed through the center of the lens formation area 401a. The exposure intensity decreases concentrically as it is closer to the periphery. It is thereby possible to expose the negative resist 210 so as to create a desired lens pattern.

After completing the exposure of the negative resist layer 210, the mother gray scale mask with lens 461 is removed from the transparent substrate 102 with the circuit element and then the negative resist layer 210 is developed. The transparent substrate 102 where the microlens array 200 is formed is thereby obtained. After that, other components as shown in FIG. 1 are formed on the transparent substrate 102, thereby producing the liquid crystal display apparatus where the microlens array 200, the TFT 108 and the aperture portion are accurately aligned.

In FIG. 19, the thicknesses and refractive indexes of the transparent substrate 102 and the exposure substrate 300 are not necessary the same as long as the optical path lengths of the transparent substrate 102 and the exposure substrate 300 are the same, in other words, as long as it satisfies t₁*n₁=t₂*n₂. It is only required that the diameter of the exposure microlens 403 and the diameter of the exposure light when reaching the negative resist layer 210 are the same, and this is satisfied if the optical path lengths are the same.

The optical path length inside the transparent substrate 102 and the optical path length inside the exposure substrate 300 may not be completely the same. This is because the exposure intensity is not affected if the spot diameter of the exposure light when reaching the boundary between the transparent substrate 102 and the exposure substrate 300, which is the vicinity of the circuit device formed on the transparent substrate 102, is smaller than the aperture portion of the circuit device. Thus, it is sufficient to satisfy the relationship of: 0.75<(t₁*n₁)/(t₂*n₂)<1.25.

Further, if the mask pattern of the lens formation area 401a is rectangle, a square lens pattern is created in the negative resist layer 210. The rectangular lens pattern is used for a lens for motion picture, and it is applied to liquid crystal televisions, for example.

Though this embodiment forms the microlens with negative resist, it is feasible to use positive resist instead of the negative resist. In this case, the lens may be formed not on the transparent substrate 102 but on another substrate.

As described in the foregoing, the positioning member 420 allows easy fixation of the position of the mother gray scale mask with lens 461 in the step of forming the microlens 202 on the transparent substrate 102.

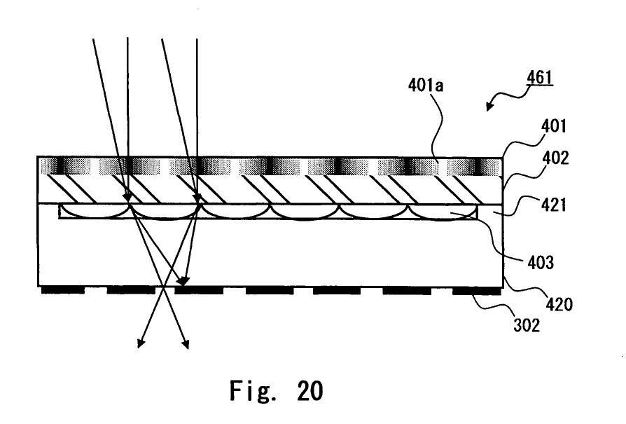

As shown in FIG. 20, a light shielding pattern 302 may be created on the opposite surface of the positioning member 420 from the surface having the exposure microlens 403. This reduces the fluctuation of light intensity due to diffusion of light and creates a more accurate lens pattern. The light shielding pattern 302 has a light shielding portion that shields light and an aperture portion that allows light to pass. The aperture portion is vertically aligned with the optical axis of the unit lens included in the exposure microlens 403.

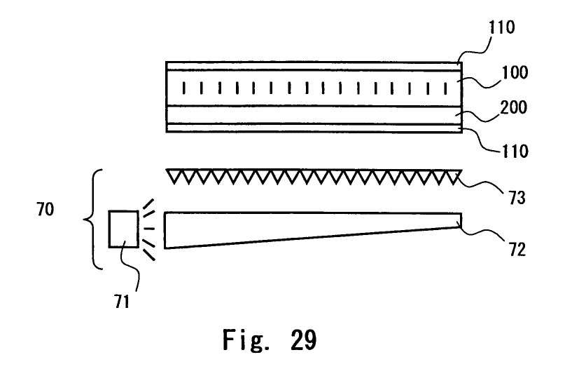

The arrows in FIG. 20 indicate the paths of the exposure light passing through the positioning member 420 when performing the exposure as in FIGS. 19A and 19B by using the positioning member 420 having the shielding pattern 302. As shown in FIG. 29, the light different from the light vertically incident on the exposure microlens 403 is blocked by the shielding portion of the shielding pattern 302 and cannot reach the transparent substrate 102. Thus, the light exposed to the negative resist layer 210 is only vertical light, and it is thereby possible to reduce the fluctuation of light intensity due to diffusion and create a more accurate lens pattern.

The fixing way and form of the positioning member 420 in the mother gray scale mask with lens 461 are not limited to those shown in FIG. 18. For example, it is feasible to form a rim that is higher than the lens height of the exposure microlens 403 on the supporting substrate 402 and attach the supporting substrate 402 and the positioning member 420 together by the rim. The rim may be formed at the same time when forming the exposure microlens 403 on the supporting substrate 402 with the same material.

The attachment point of the positioning member 420 is not limited to the projecting portion 421 or the rim but may be the top part of the exposure microlens 403. Further, the exposure microlens 403 and the positioning member 420 may be attached by filling resin material into a gap therebetween and curing the resin.

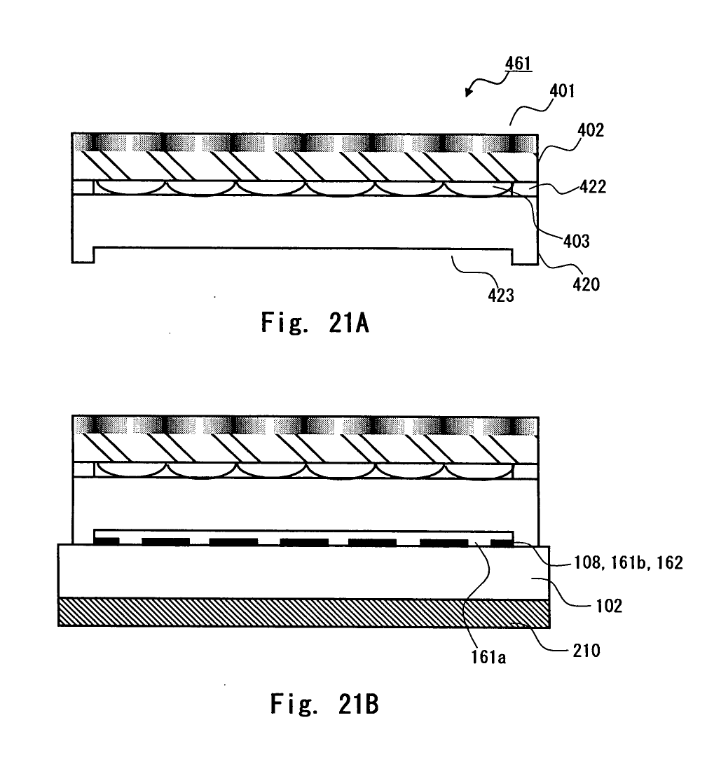

Further, the surface of the positioning member 420 to be placed on the circuit element may have a depressed portion 423 as shown in FIG. 21A. The depressed portion 423 prevents the positioning member 420 from attaching the TFT 108 in the fabrication process of the microlens 202 on the transparent substrate 102 as shown in FIG. 21B. It is thereby possible to reduce the risk of damaging the TFT 108 during the fabrication process and increase yields.

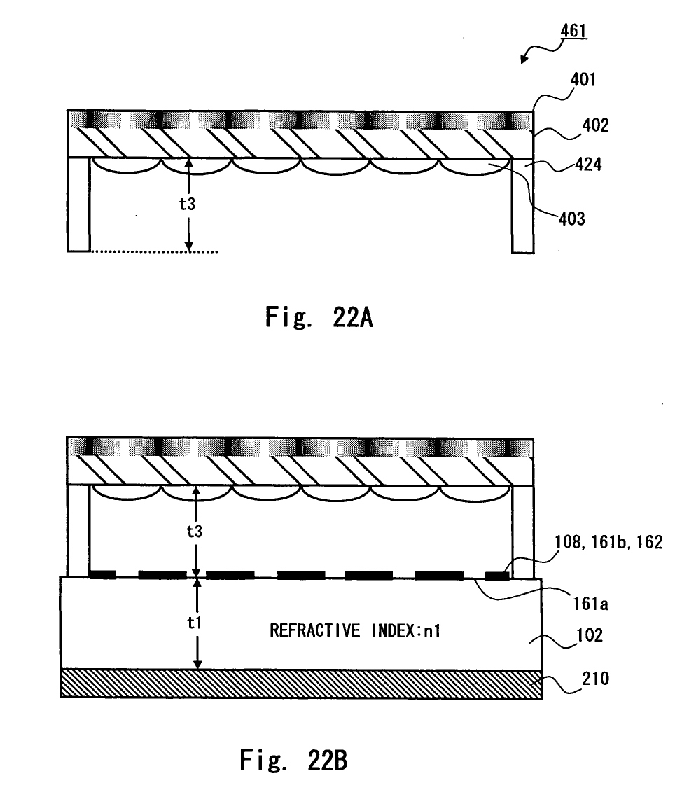

Alternatively, it is feasible to fix the mother gray scale mask 460 by forming a rim 424 that is higher than the lens height of the exposure microlens 403 without using the positioning member 420 as shown in FIG. 22A. In this case, the same effect as above can be obtained if the height (t₃) of the rim 424 is substantially the same as the focal length of the exposure microlens 402 in the air.

As shown in FIG. 22B, the transparent substrate 102 and the exposure microlens 403 are separated from each other by the height of the rim 424 or t₃. An air space is thereby created between the transparent substrate 102 and the exposure microlens 403. The relationship of t₃ and t₁ is important since it is necessary to adjust t₃ so that the optical length in the air space and the optical length in the transparent substrate 102 are substantially the same. It is thus necessary to satisfy the relationship of t₃=t₁*n₁.

In addition, the focal length of the exposure microlens 403 is also substantially the same as t₃. Thus, the focal point of the exposure microlens 403 is in the vicinity of the boundary between the air space and the transparent substrate 102. Further, the center of the lens formation area 401a, the optical axis of the unit lens included in the exposure microlens 403, and the aperture 161a of a wiring member formed on the transparent substrate 102 are vertically aligned.

If the microlens 202 is formed in the above process, it is not necessary to contact another component to the surface of the transparent substrate 102 where the circuit element is formed, and the surface with the circuit element faces the air space. Therefore, there is no risk to damage the circuit element by contact with another component, thus increasing yields. Though the above embodiment defines the TFT 108 and the transparent electrode 106 as the circuit element, the circuit element may not include both of them but may include either one of them. Further, the circuit element may include another component such as the pixel electrode 161.

### Fifth Embodiment

A fifth embodiment of the present invention describes a modified form of the method of fabricating a plurality of microlens arrays on the liquid crystal substrate, which is the fourth step in the second embodiment. In this embodiment, the microlens 202 is formed not by the intensity modulation by the gray scale mask but by using a stamper such as a die having a depressed portion with a desired shape.

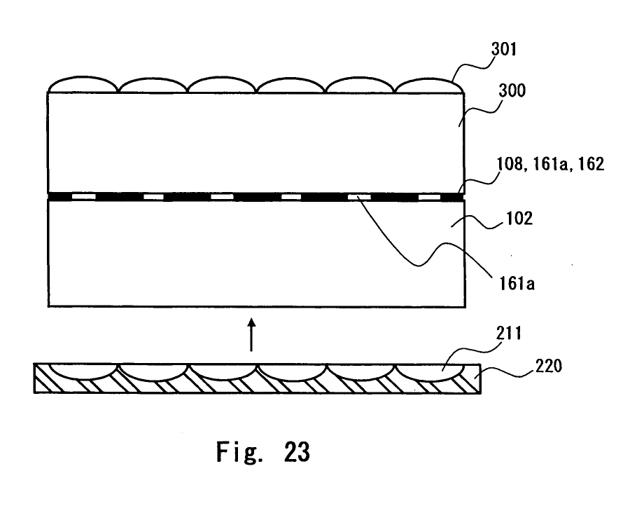

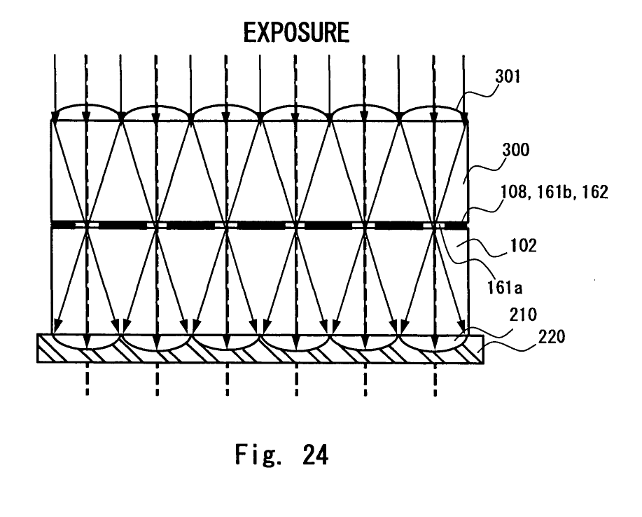

As shown in FIG. 23, an exposure substrate 300 is placed on the front side of the transparent substrate 102. The exposure microlens 301 is formed on the opposite surface of the exposure substrate 300 from the surface facing the transparent substrate 102. In the backside of the transparent substrate 102, a stamper filled with photocurable resin 211 is placed. The stamper 220 is a mold that has a depressed portion with a shape that can transfer the shape of the microlens 202 to be formed, and it is Ni die, for example. The photocurable resin 211 is mainly UV curable resin having transparency such as acrylic resin.

The photocurable resin 211 is exposed through the exposure substrate 300. In this exposure, UV light with the wavelength of about 365 nm is applied at the energy of 3000 ml. FIG. 24 shows the light rays of the exposure light. The exposure light passes through the aperture 161a and enters the transparent substrate 102 to expose the photocurable resin 211 in the stamper 220.

Since this embodiment uses the stamper 220, it eliminates the need for using the gray scale mask 400 as in the first embodiment. Further, since this embodiment only requires that the exposure light through the exposure substrate 300 reaches the stamper 220 without being blocked by the wiring member such as the TFT 108, it eliminates the need for adjusting the optical path lengths of the exposure substrate 300 and the transparent substrate 102 as in the first embodiment.

### Sixth Embodiment

A sixth embodiment of the present invention describes a microlens array that is fabricated according to the method described in the second to sixth embodiments and a liquid crystal display apparatus that has the microlens array.

First, the shape of the microlens 202 described in the embodiment of the invention is described in comparison with the method of forming the microlens 202 by reflowing material that has been used conventionally.

When the bottom surface of the microlens 202 is polygonal-shaped such as hexagon, a conventional method of using reflowing (which is referred to hereinafter simply as the reflowing) has a problem that it is difficult to make a fixed curvature radius of the lens. When using the reflowing, the lens curvature radius is determined by the apex of the center of the lens and the periphery of the lens. If the lens bottom surface is round, the lens curvature radius is the same in given diameter directions. Otherwise, for example if it is hexagonal as in this embodiment, the length of the line segment connecting the lens center and the lens periphery differs by diameter direction, and therefore the lens curvature radius is different. For the purpose of increasing backlight use efficiency by arranging the microlenses on the transparent substrate 102 without any space therebetween, the bottom shape of each microlens is preferably polygon where the distance from the center to the periphery is not the same, and it may be rectangle, for example. Hence, it is not preferred to use reflowing for the formation of the microlens 202.

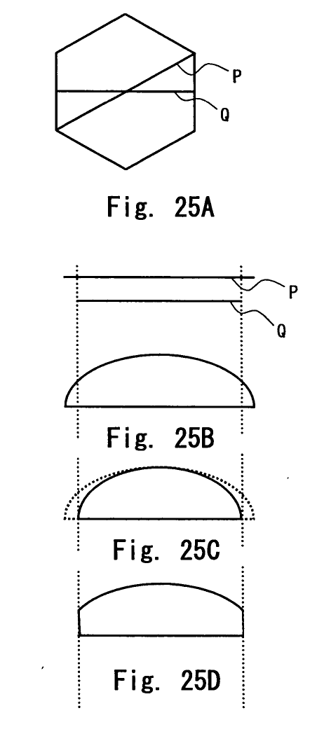

The case where the lens bottom surface shape is regular hexagonal is described herein with reference to FIGS. 25A to 25D. As shown in FIG. 25A, if the lens bottom surface is regular hexagonal-shaped when viewed from above, a line segment P that goes through the center and connects the opposing vertexes is the longest and a line segment Q that goes through the center and connects the midpoints of the opposing sides is the shortest. The length of the line segment Q is approximately 87% of the length of the line segment P. In the reflowing, the lens section in the line segment P is formed as shown in FIG. 25B and the lens section in the line segment Q is formed as shown by the full line in FIG. 25C. As shown in FIG. 25C, the curvature radius of the lens section is different in the diameter direction of the line segment P and the line segment Q. The difference in curvature radius causes the focal points to differ in the diameter direction of the line segments P and Q. If the focal point is not fixed, it is unable to efficiently focus the light entering the microlens 202 onto one point and thus unable to focus the backlight onto the aperture portion 161.

In this embodiment, the lens section at the line segment Q is as shown in FIG. 25D. Thus, the curvature radius of the lens section at the line segment Q is the same as the curvature radius at the line segment P and the edges are vertically cut out, and the lens width is the length of the line segment Q. This lens shape does not cause the curvature radius to differ by diameter directions. As shown in FIGS. 25B and 25D, the maximum curvature radius and the minimum curvature radius of the microlens 202 are preferably the same. At least, the minimum curvature radius is 80% or higher, preferably 82% or higher, and more preferably 90% or higher of the maximum curvature radius. The maximum curvature radius and the minimum curvature radius are the same as shown in FIGS. 25B and 25D.

The stability of the curvature of the microlens 202 is evaluated also by a degree of sphericity. The rms (root mean square) to evaluate the degree of sphericity is represented as follows:

$$rms = \sqrt{{\sum }_{i = 0}^{n} {( f ( i ) - g ( i ) )}^{2} / n} \qquad ( 3 )$$

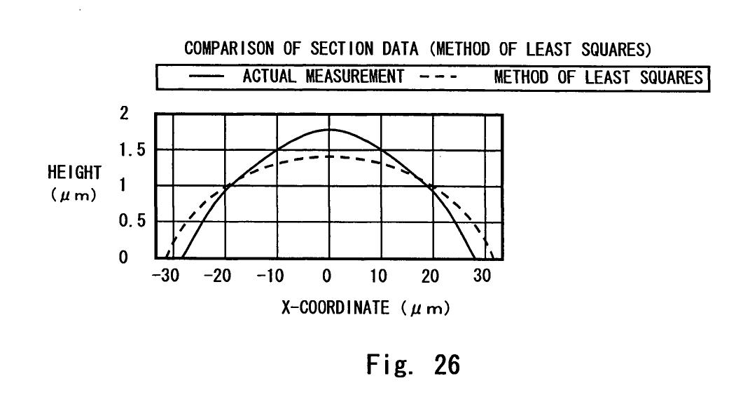

FIG. 26 is a graph showing a measurement result of the degree of sphericity of the microlens. The degree of sphericity evaluates a deviance from the spherical curvature after fitting by the method of least squares for each section going through the lens center with rms value calculated from the difference. If the value is smaller, it indicates that the lens curvature is more similar to the sphericity and the curvature is more stable. The degree of sphericity of the microlens, which is rms value, is preferably from 0.005 to 0.2 and more preferably from 0.005 to 0.15. The rms value of the microlens of this embodiment is 0.04.

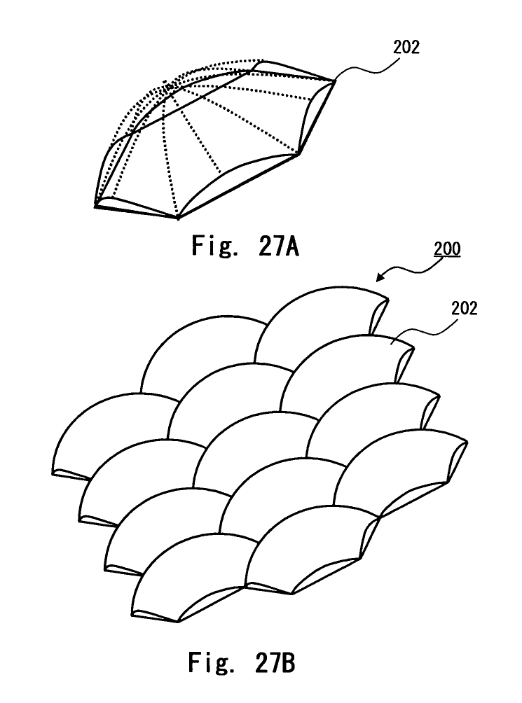

FIGS. 27A and 27B show perspective views of the microlens 202 of this embodiment. FIG. 27A is a perspective view of the microlens 202 of this embodiment and the dotted line indicates the ark showing the lens surface. As shown in FIG. 27A, in the microlens 202 of this embodiment, the arc reaches the lens bottom surface in the line segment connecting the opposing vertexes while the arc is disconnected when it reaches the lens periphery in the line segment going through the lens center and connecting the facing sides. FIG. 27B is a perspective view where the lenses shown in FIG. 27A are arranged without any space therebetween.

As described above, the microlens having the structure as shown in FIG. 27 is difficult to form by the reflowing. Therefore, the microlens 202 according to this embodiment is preferably formed by a fabrication process using 2P (Photo-Polymer) process or exposure using the gray scale mask. The 2P process fills photocurable resin into a stamper having a mold that can transfer a desired curvature shape, presses the stamper against the transparent substrate 102, and exposes to harden the photocurable resin in the mold of the stamper, thereby forming the shape of the microlens 202. The exposure process using the gray scale mask exposes the negative resist formed on the transparent substrate 102 through the gray scale mask having a desired mask pattern, thereby hardening the negative resist into a desired shape.

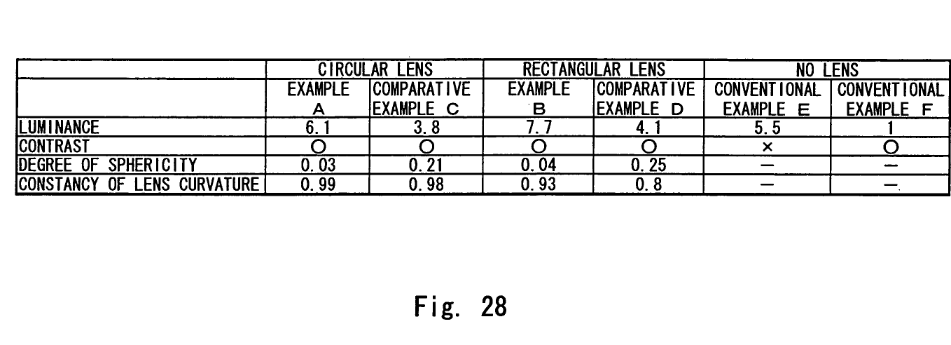

FIG. 28 shows a table to compare luminance, contrast, degree of lens sphericity, and constancy of lens curvature about a liquid crystal display apparatus of this embodiment and liquid crystal display apparatus of a comparative example and a conventional example. The degree of sphericity is rms value represented by the expression (3) and the constancy of curvature is a ratio of the minimum curvature radius of the lens with respect to the minimum curvature radius of the lens. The microlens used for this comparison is circular or rectangular. Such a microlens can be formed by the 2P process or a fabrication process using exposure with the gray scale mask.

The case using the liquid crystal display apparatus of this embodiment having a circular lens is example A, the case using the apparatus having a rectangular lens is example B. As comparative examples, the case using a liquid crystal display apparatus having a circular microlens formed by reflowing negative resist is comparative example C, the case using the apparatus having a rectangular microlens formed by the same process is comparative example D. As conventional examples, the case using a liquid crystal display apparatus where all electrodes in the wiring member are formed by transparent electrodes without having microlenses is conventional example E and the case using the apparatus where a transparent electrode with a diameter of 35 μm is placed at the center of the pixel electrode and the other part is used as a reflecting electrode is conventional example F.

In the conventional example that has no microlens, the conventional example E had insufficient contrast and a display appears white under sunlight. Though the contrast under sunlight was suitable in the conventional example F, the luminance when using indoors was low and thus an image was not clear. The examples A and B showed high visibility under sunlight and produced sufficient luminance even for the use in room, and an image was displayed clearly. On the contrary, the comparative examples showed a low degree of sphericity of the lens and a low light focusing rate, thus causing darkness for use in room so that a clear image display was failed.

The influence of the thickness of the transparent substrate 102 in the backlight side of the liquid crystal panel 100 and the components of backlight emitted from the backlight to enter the liquid crystal panel 100 on the optical effects by the microlens is described herein. FIG. 29 is a schematic sectional view showing a liquid crystal display apparatus and a backlight unit 70. As shown in FIG. 29, the backlight unit 70 of this embodiment has a backlight source 71, a light guide plate 72, and a prism sheet 73. Though conventional backlight units further have a diffusion sheet, since the light focused on the aperture portion 161a of FIG. 2 by the microlens array 200 is diverged after passing through the aperture portion 161a in this embodiment, it is possible to obtain the same effect as the diffusion sheet. Therefore, the need for the diffusion sheet is eliminated, allowing size reduction of the backlight unit 70 and cost reduction.

The backlight source 71 is a light emitting portion of the backlight unit 70 and it generally uses light emitters of four or two white LED. The backlight unit 70 is an edge-light backlight unit, and the backlight source 71 is placed at the side surface of the backlight unit 70. The light emitter used for the backlight source 71 is not limited to the white LED, and white light may be produced by mixing red, blue and green LED light. Use of a cold-cathode tube is also possible. Use of LED for the backlight source 71 allows improvement in color reproduction.

The light guide plate 72 guides the light from the backlight source 71 toward the prism sheet 73. The light guide plate 72 of this embodiment is a knurling light guide plate having a triangular groove. The light guide plate 72 is mainly made of acrylic resin.

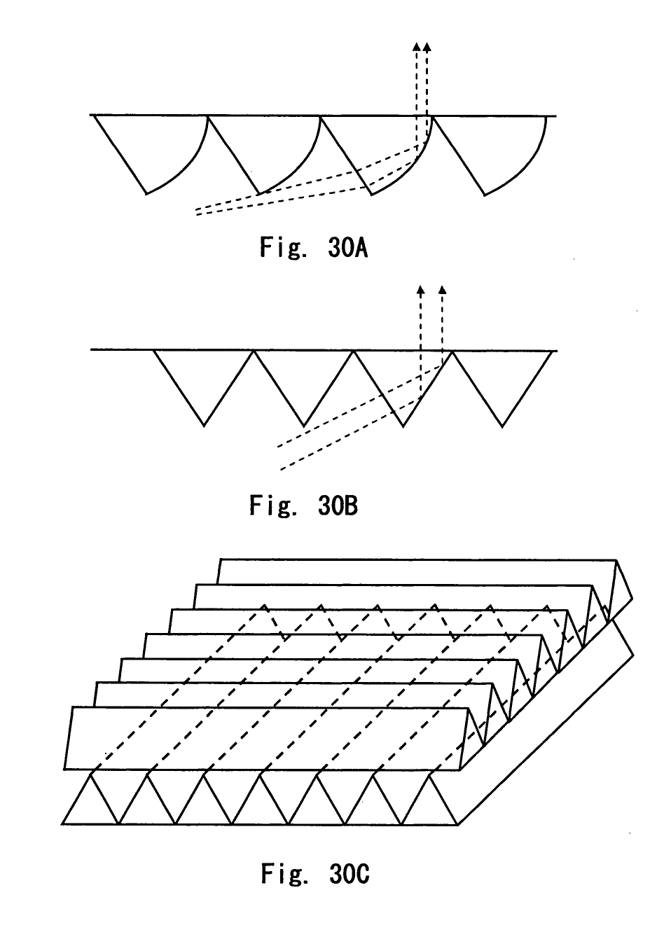

The prism sheet 73 polarizes the light that is guided to the liquid crystal panel 100 by the light guide plate 72 into substantially vertical light to the liquid crystal panel 100. FIGS. 30A to 30C are pattern diagrams showing the vertical polarization by the prism sheet 73. The prism sheet 73 of this embodiment is a light collecting prism sheet where fan-shaped prisms having a convex curved surface are arranged. Unlike a normal triangular prism, this prism polarizes light by the arc surface to enable accurate vertical polarization, thereby changing the intensity distribution of backlight so that the vertical components are strong. As the prism sheet 73, a prism sheet for high luminance, Diaart which is a trademark of and available from Mitsubishi Rayon Co., Ltd may be used. Even if light is polarized vertically with the prism sheet 73, the light still have some emission components. However, by adjusting the triangular groove of the light guide plate 72 and the prism apex of the prism sheet 73, it is possible to control the emission angle of the emission components included in the light.

Besides the arrangement of FIG. 30a, the triangular prisms may be arranged so that the apexes face the light guide plate to vertically polarize light as shown in FIG. 30B. In this case also, it is possible to control the emission angle of the vertical polarization by adjusting the triangular groove of the light guide plate 72 and the apex of the triangular prism. Further, two prisms may be arranged so that they cross each other at an angle of 90 degrees as shown in FIG. 30C.

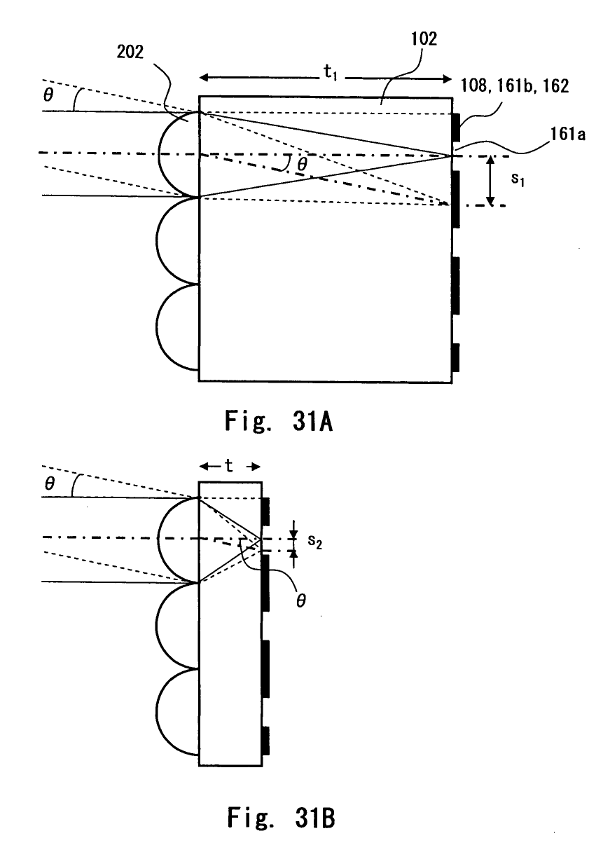

In the liquid crystal display apparatus having the structure shown in FIG. 1, the thickness of the transparent substrate 102 and the emission components of the light emitted from the backlight unit 70 to enter the liquid crystal panel 100 greatly affect the display luminance of the liquid crystal display apparatus. FIGS. 31A and 31B show the relationship between the thickness of the transparent substrate 102 and the incident angle of the backlight onto the microlens 202. The emission angle θ is defined as emission angle of backlight to the microlens 202. FIG. 31A shows the case where the light incident on the microlens 202 at an angle θ is blocked by the reflecting portion 161b when the transparent substrate 102 has a thickness of t₁. If a deviance of the focal point of the microlens 202 from the optical axis is s₁, s₁=t₁*θ/n. Thus, the smaller the value of t₁ is, the smaller the value of s₁ is.

FIG. 31B shows the form where the thickness of the transparent substrate 102 is reduced. FIG. 31B shows the case where the light incident on the microlens 202 at an angle θ passes through the aperture portion 161a when the transparent substrate 102 has a thickness of t₂. The value of t₂ is smaller than t₁. As described above, a deviance of the focal point of the microlens 202 is s₂=t₂*θ/n. Since the value of t₂ is smaller than t₁, the value of s₂ is smaller than s₁ as shown in FIG. 31B. Reducing the thickness of the transparent substrate 102 allows increasing the proportion of the incident light to pass through the aperture portion 161a.

The angle θ of the light before entering the microlens 202 is the same as the angle of emission component of the backlight emitted from the backlight unit 70 and entering the liquid crystal panel 100. Thus, the angle of the emission component of the backlight affects a deviance from the optical axis as the incident angle θ to the microlens 202, and the smaller the value of θ is, the smaller the deviance from the optical axis is.

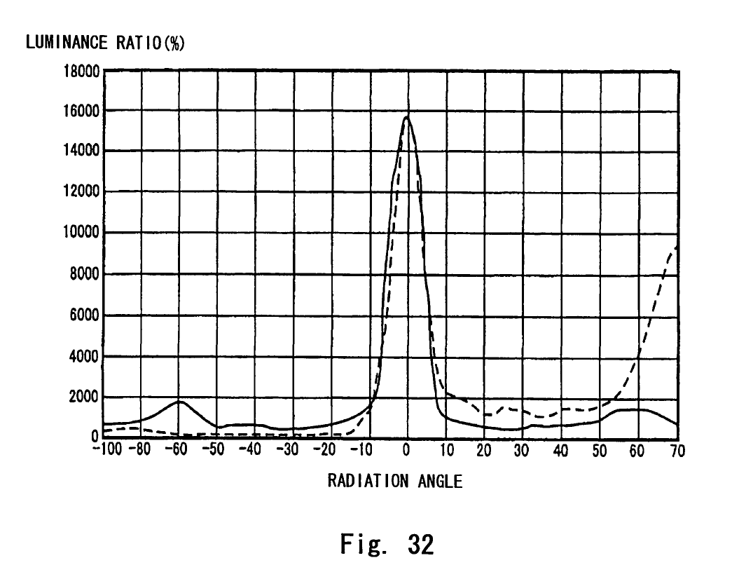

FIG. 32 is a graph showing the relationship of the light emission angle θ from the prism sheet 73 and the luminance ratio in the backlight unit of this embodiment shown in FIG. 29. In FIG. 32, the full line and dotted line are orthogonal to each other in the direction of the emission angle θ. The full line indicates the emission angle in the longitudinal direction of the backlight source 71 and the light guide plate 72, and the dotted line indicates the emission angle in the lateral direction. As shown in FIG. 32, the light intensity of the backlight source 71 has Gaussian distribution. The prism sheet 73 used in this example has the structure shown in FIG. 30B.

As shown in the graph of FIG. 32, the backlight unit used in this embodiment emits the light whose intensity gradually decreases toward left and right, centering the vertical component. The intensity distribution of the backlight can be regarded as Gaussian distribution. In consideration of up to the angle indicating the intensity that is 20% of the maximum intensity or the vertical component intensity in this light intensity distribution, 90% or higher of all energy of backlight is used. Thus, assuming the range of the emission angle having the light intensity of 20%, the effects of the focusing properties of the lens can be defined sufficiently. Though it can be left-right asymmetric with respect to the vertical component according to the structure of the backlight unit, an average value of the emission angles having a left and right light intensity of 20% may be defined as an emission angle as long as it is not extremely asymmetric such as +5° and −30°.

As shown in FIG. 32, use of the prism sheet 73 of this embodiment causes the light intensity to be more centered. It is thereby possible to improve light use efficiency with lower emission components. Further, in consideration of this light intensity distribution, it is not necessary to focus all the emission components of light. Light use efficiency can be sufficiently improved if the emission components in a certain angle range from the vertical component can be focused. This embodiment defines the angle where luminance is 20% of center luminance as an emission angle of light.

The graph of FIG. 32 shows a measurement result in one form of the prism sheet 73 and the light guide plate 72. It is possible to adjust the emission angle by adjusting the apex of the prism of the prism sheet 73 and the triangular groove of the light guide plate 72.

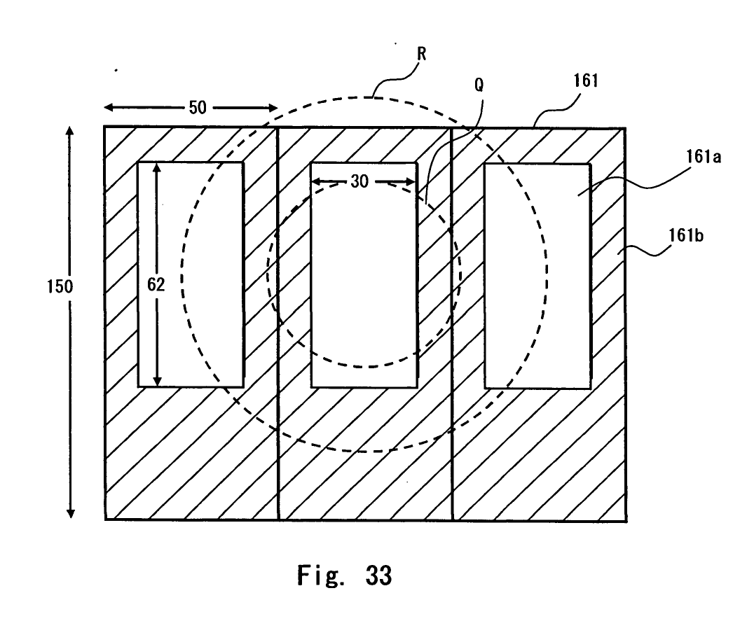

If the emission angle θ of backlight and the thickness of the transparent substrate 102 are determined, the spot diameter of the light focused by the microlens 202 when it reaches the pixel electrode 161 can be obtained by using the calculation method described in FIGS. 31A and 31B. FIG. 33 is a view that illustrates the spot diameter for each emission angle θ with a circle when the thickness of the transparent substrate 102 is 300 μm. The circle Q indicates the spot diameter when an emission angle θ is 8 degrees, and the circle R indicates the spot diameter when an emission angle θ is 15 degrees. The center of the microlens 202 and the aperture portion 161a correspond to each other.

In FIG. 33, the pixel electrode 161 is 50 by 150 μm in size, and the aperture portion 161a is 30 by 62 μm in size. Thus, a pixel aperture ratio is about 25%. As shown in FIG. 33, the spot diameter protrudes from the aperture portion 161a by the emission components of backlight. The light intensity is not distributed uniformly in the circle Q or R, and the peak of the light intensity is at the center as described above. This distribution is assumed to be Gaussian distribution.

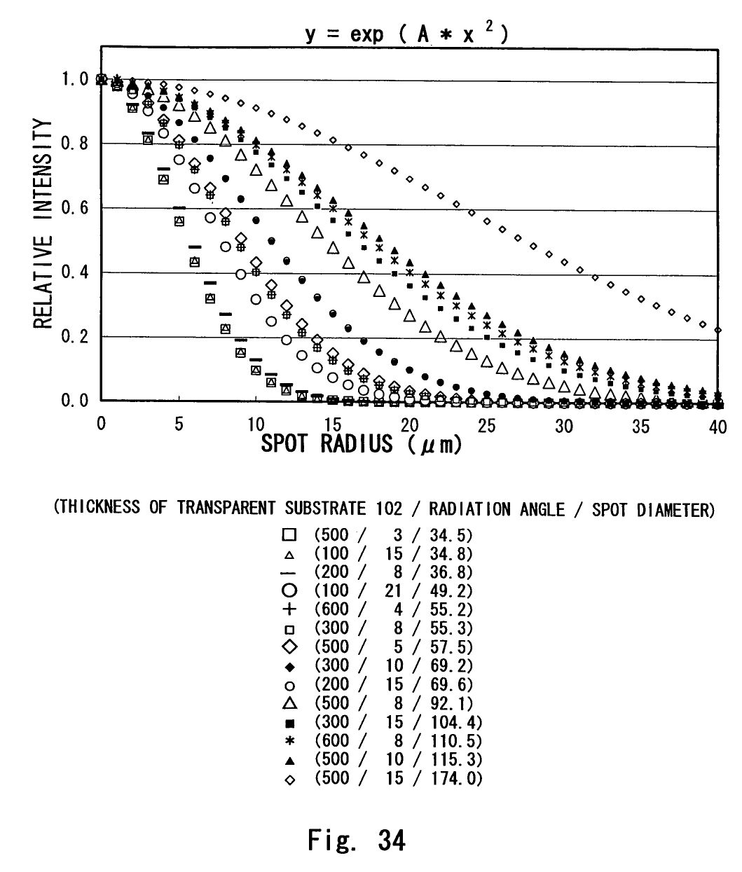

The distribution of light emission components is Gaussian distribution as shown in FIG. 32. Thus, the graph as shown in FIG. 34 can be obtained by Gaussian approximation with the expression of y=exp(A*x²) where the emission angle θ and the thickness of the transparent substrate 102, which are shown in FIGS. 31A and 31B, are parameters, the horizontal axis is a stop radius, and a light intensity at the center is defined as 1. A is a normalization constant to standardize center luminance to 1. The graph of FIG. 34 shows the light intensity distribution with respect to the distance from the lens optical axis when the light focused by one microlens 202 reaches the pixel electrode 161. As described above, the angle where luminance reaches 20% of center luminance of light emission components is defined as the emission angle. Thus, the luminance at the outermost part of the light before being focused by the microlens 202 is 20% of the center luminance. After the light is focused by the microlens 202, the light intensity of the part corresponding to the outermost part of the light before being focused is almost 0 or reaches 0 by the focusing effects of the microlens 202 as shown in FIG. 34.

As indicated by the parameters of FIG. 34, as the thickness of the transparent substrate 102 increases and the emission angle θ of the backlight decreases, the light intensity approaches the center to make a sharp distribution where the spread of light, which is a spot diameter, is small. If full-circle integration centering on the spot radius=0 μm is performed on each graph of FIG. 34, the intensity of the light focused by one microlens 202 (which is referred to herein as I₁) is obtained. However, since the graph of FIG. 34 is standardized as the center light intensity to 1, the value I₁ obtained by the full-circle integration merely indicates the light intensity distribution for each parameter and it is not possible to compare the graphs with different parameters.

On the other hand, the intensity of incident light to one microlens 202 is expressed as 150*50*I₀ if backlight intensity per unit area is I₀. To simplify the calculation, I₀ is assumed to be 1. For I₁, if the coefficient to eliminate the standardization of the center intensity to 1 so as to make it correspond to I₀ is k, k*I₁=150*50*I₀.

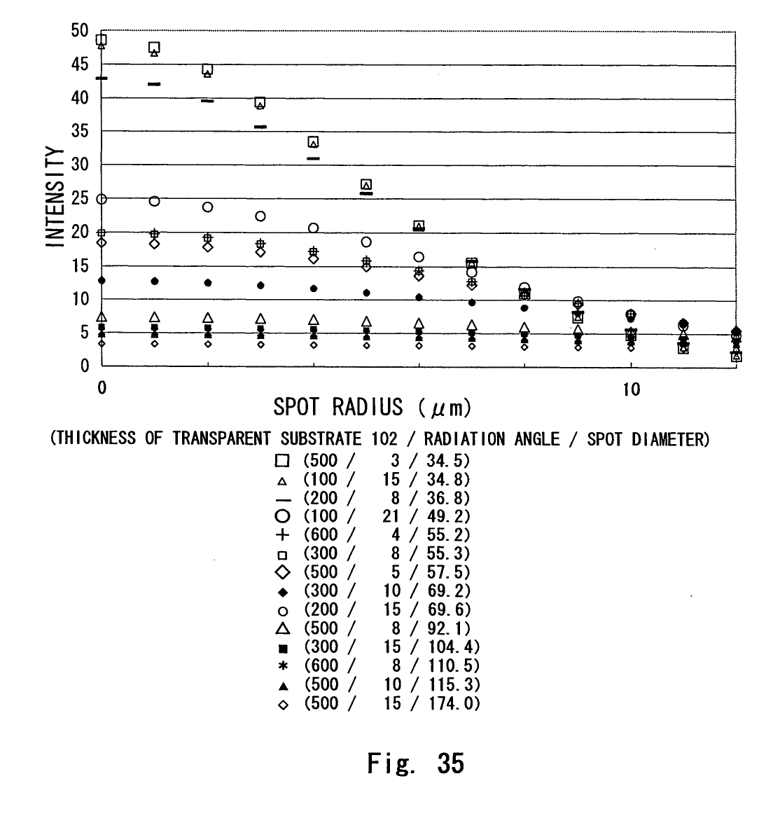

By obtaining the coefficient k for each parameter with this calculation and multiplying each parameter by the corresponding coefficient k, it is possible to obtain the graph of FIG. 35 that shows the light intensity distribution with respect to a distance from the lens optical axis. FIG. 35 shows the light intensity distribution when the light focused by one microlens 202 reaches the pixel electrode 161 where the emission angle θ and the thickness t of the transparent substrate 102, which are shown in FIGS. 31A and 31B, are parameters. Since the standardization is eliminated by the coefficient k, the graph shows relative light intensity of the parameters. The light intensity is dimensionless since the light intensity I₀=1 per unit area of backlight is assumed. As shown in FIG. 35, the light intensity is concentrated on the vicinity of the lens optical axis as the emission angle is smaller and the thickness of the transparent substrate 102 is also smaller.

Thus, it is not necessary that all spot diameters of the light focused by the microlens 202 and reaching the pixel electrode 161 are included in the aperture portion 161a. The light use efficiency can be improved if about half of the radius of the circle indicated as a spot is included in the aperture portion 161a.

The backlight has the intensity distribution as shown in FIG. 35 by emission components of light even after it is focused by the microlens 202. By performing full-circle integration centering on the vertical axis on the graph of FIG. 35, it is possible to obtain the intensity of backlight focused by one microlens 202. As shown in FIG. 33, the aperture portion 161a of the pixel electrode 161 is 30 by 62 μm in size. Thus, the emission component of up to 30 μm in the lateral direction and up to 62 μm in the horizontal direction passes through the aperture portion 161a and is eventually used as backlight.

In order to obtain the intensity of the light that passes through the aperture portion 161a and is used as backlight finally, which is referred to herein as I₂, the horizontal axis of FIG. 35 is divided at a half value of the aperture diameter of the aperture portion 161a, which is referred to herein as φ, or the aperture radius φ/2, and then the full-circle integration is performed in the divided range.

The aperture portion 161a is rectangular and a distance from the center is not uniform. Thus, the integration range in the horizontal axis is not fixed. Thus, in order to obtain the light intensity that passes through the aperture portion 161a and is used as backlight, the length of the side of the aperture portion 161a in the short side direction may be used. It is feasible to use an intermediate value of the short side direction and the long side direction of the aperture portion 161a. It is also feasible to obtain an average length from the center to the periphery of the aperture portion 161a and use it as φ/2. Specifically, if the aperture portion 161a is rectangle, the light intensity is calculated by (long side+short side)/2. If it is a regular polygon of pentangle or above or ellipse, the light intensity is calculated by (short axis+long axis)/2. In this embodiment, the radius of the maximum circle that can be included in the aperture portion 161a is φ/2.

In this embodiment, the range to divide the horizontal axis of FIG. 35 is a midpoint of the horizontal length 30 μm and the vertical length 62 μm of the aperture portion 161a. Thus, since an average of the horizontal length 30 μm and the vertical length 62 μm is 46 μm, full-circle integration is performed on the range up to 23 μm, which is half of the average value, centering on the spot diameter=0 μm.

When backlight is incident on the microlens 202 and the transparent substrate 102, it is affected by the incident angle θ due to a difference in refractive index before incidence and after incidence. It is assumed that a refractive index of an area before the backlight is incident on the microlens 202 and/or the transparent substrate 102 is 1, a refractive index after the backlight is incident thereon is n; thus, a ratio of refractive indexes before incidence and after incidence is n. In this embodiment, backlight is in the air before it is incident on the microlens 202 and the transparent substrate 102, and a refractive index of the light after incidence is 1.52.

Light use efficiency E can be obtained by dividing I₂ that is obtained as above by I₁. Using the above factors, which are an incident angle θ (rad), thickness of the transparent substrate 102 (μm), aperture diameter φ of the aperture portion 161a (μm), and refractive index n of the microlens 202 and the transparent substrate 102, if a parameter to indicate a ratio of the spot radius of light focused by the microlens 202 and the aperture diameter φ of the aperture portion 161a is a constant P, it is represented as P=(φ*n)/(θ*t).

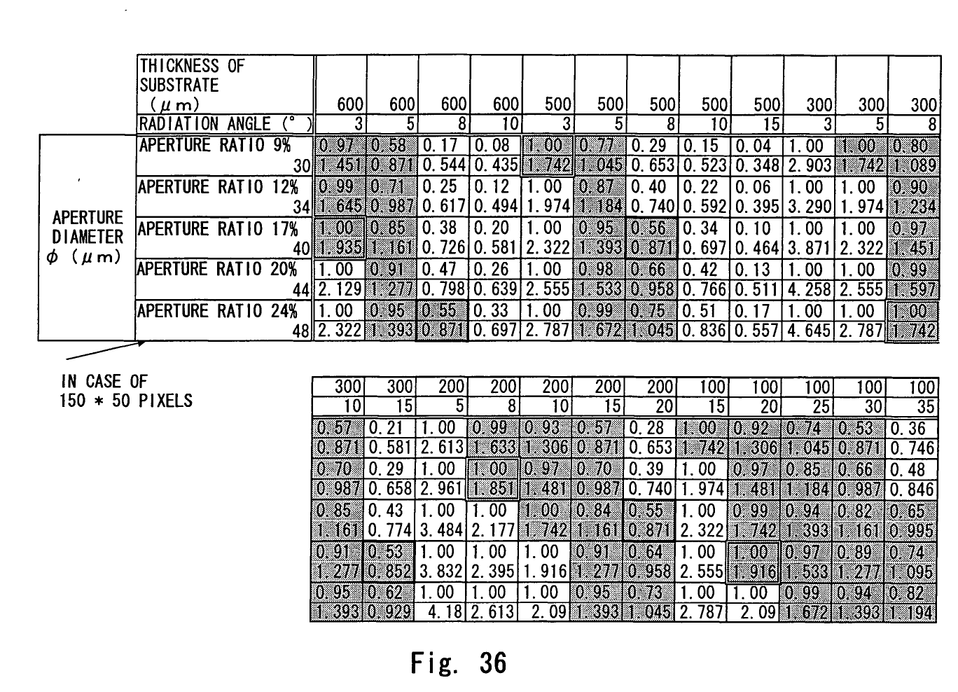

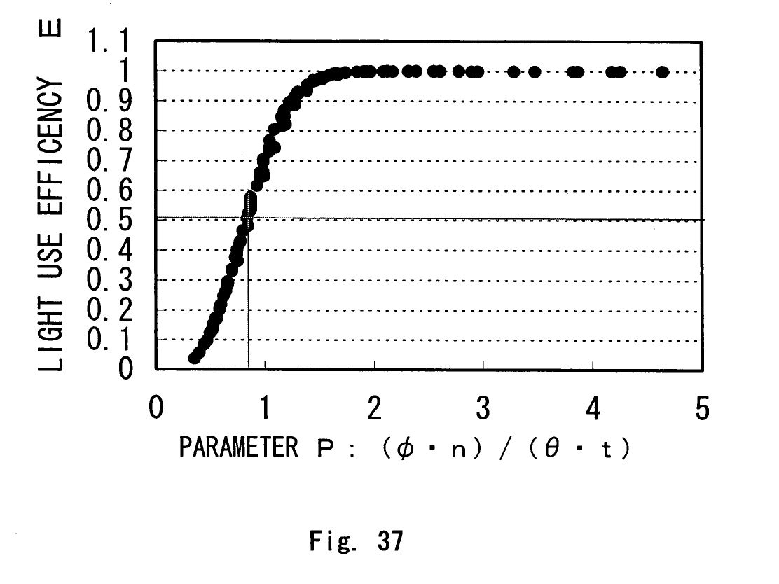

FIG. 36 shows a parameter P by each value on which a parameter P depends in the lower stand and a value of light use efficiency E corresponding thereto in the upper stand. FIG. 37 shows a plot where the horizontal axis is a parameter P and the vertical axis is light use efficiency E. The light use efficiency E is a proportion of the intensity of backlight having passed through the aperture portion 161a with respect to the intensity of backlight. A maximum value is 1 when the backlight is not blocked by the reflecting portion 161b at all and focused by the microlens 202 to pass through the aperture portion 161a. If the microlens 202 is not used, the aperture ratio of the pixel electrode 161 is the light use efficiency E.

FIG. 36 shows that the light use efficiency E is higher if each value of the emission angle θ and the thickness t of transparent substrate 102 is smaller and the value of the aperture diameter φ is larger, which is, the value of the parameter P is greater. The effect of the microlens 202 is exerted suitably if the light use efficiency E is defined. Since the aperture ratio of the semi-transmissive liquid crystal display apparatus is presently about 25%, the light use efficiency E is about 0.25 if the microlens 202 is not used. Thus, if this embodiment defines higher light use efficiency, it is possible to obtain higher luminance than a conventional semi-transmissive liquid crystal display apparatus. If the light use efficiency E is 0.5 or higher, a very high performance apparatus having brightness of substantially more than double the brightness of a present apparatus can be obtained. If the aperture ratio is 50%, it is possible to obtain light use efficiency E of 0.5 or higher.

In FIG. 36, the cells having light use efficiency E of 0.5 or higher are indicated by hatching. If the light use efficiency is 1.0 at a plurality of different aperture ratios with the same substrate thickness and the same emission angle, only the cell having the lowest aperture ratio is indicated by hatching. Further, if the light use efficiency is 1.0 at a plurality of different emission angles with the same substrate thickness and the same aperture ratio, only the cell having the lowest emission angle is indicated by hatching.

This is described in detail by defining the light use efficiency E as about 0.5. In FIG. 36, the data where the light use efficiency E is 0.5 or higher and about 0.5 is indicated by a thick frame. The lowest value of the parameters P corresponding to these values is 0.852 where the thickness t of the transparent substrate is 300 μm, incident angle θ is 15 degrees, and aperture ratio is 20%. E is 0.53. Thus, in order to define that the light use efficiency E is 0.5 or higher, the value of the parameter P is preferably 0.8 or higher and more preferably 0.85 or higher.

A maximum value of the light use efficiency E is 1 where backlight is used without any loss. As shown in FIG. 37, the light use efficiency E reaches 1 when the value of parameter P is about 1.7. Even if each component is designed so that the value of parameter P is higher, the optical effect does not improve. However, in order to increase the value of the parameter P, it is necessary to reduce the thickness t of the transparent substrate 102, narrow down the emission angle θ or enlarge the aperture diameter φ.

This embodiment calculates the thickness t of the transparent substrate 102 in the range of 100 to 600 μm. If the thickness of the transparent substrate 102 is smaller than 100 μm, it is difficult to assure the strength of the liquid crystal panel 100, which causes deterioration in yield and decrease in the strength of liquid crystal display apparatus. On the other hand, if the thickness of the transparent substrate 102 is larger than 600 μm, it goes against the need for smaller liquid crystal display apparatus. More preferably, the thickness t of the transparent substrate 102 is 200 to 400 μm. It is thereby possible to achieve both a thinner semi-transmissive liquid crystal display apparatus and a stronger transparent substrate.

Reduction of the emission angle θ requires higher collimating performance, which is technically difficult. Though the emission angle θ is preferably 5 degrees or lower, it is easy to achieve the range of 5 to 10 degrees. Further, increasing the aperture diameter φ decreases the light use efficiency of reflected light, which deteriorates the performance of a semi-transmissive liquid crystal display apparatus. For these reasons, defining the upper limit of the parameter P makes it possible to draw more suitable design conditions by avoiding unwanted restriction to the conditions of designing semi-transmissive liquid crystal display apparatus while exerting the optical effects of the microlens 202.

This is described in detail herein, defining the light use efficiency E to 1 or lower. In FIG. 36, the cell having a relatively low parameter P with light use efficiency of 1 is surrounded by double frames. The lowest value of the parameters P corresponding to these values is 1.7418 where the thickness t of the transparent substrate is 300 μm, incident angle θ is 8 degrees, and aperture ratio is 24%. Thus, in order to define that the light use efficiency E is 1 or lower, the value of the parameter P is preferably 2 or lower and more preferably 1.75 or lower.

As shown in the graph of FIG. 37, the value of the light use efficiency E for the value of parameter P changes greatly until the parameter P is approximately 1.2 and then changes gradually until it reaches 1. Thus, until the value of the parameter P becomes approximately 1.2, reducing the thickness t of the transparent substrate 102 and narrowing the emission angle θ bring a large increase in optical effects. However, if the value of the parameter P becomes 1.2 or higher, an increase in optical effects with respect to a change in the values of t and θ becomes slow. As described above, reducing the thickness t of the transparent substrate 102 decreases the strength of liquid crystal display apparatus; further, narrowing the emission angle θ is technically difficult. Hence, by drawing the range where large optical effects are obtained from FIGS. 36 and 37, it is possible to achieve more efficient design and manufacture of liquid crystal display apparatus.

If the value that is most suitable for the value of parameter P is drawn, when the thickness t of the transparent substrate 102 is 300 μm and the incident angle θ is 8 degrees, it is possible to obtain light use efficiency E of 0.8 or higher even if the aperture diameter φ is 300 μm, that is, the aperture ratio is 9%. In a semi-transmissive liquid crystal display apparatus of a conventional technique, the light use efficiency E is 0.09 when the aperture ratio is 9% and the light use efficiency of backlight decreases greatly, and therefore such a low aperture ratio is not practical. However, the semi-transmissive liquid crystal display apparatus of this embodiment can achieve the light use efficiency E of 0.8 while the aperture ratio is 9%.

FIG. 36 also shows that if the thickness t of the transparent substrate is small (for example, 300 μm or lower) and the incident angle θ is narrow (for example, 5 degrees or smaller), it is possible to obtain light use efficiency of 0.5 or higher even when the aperture ratio is further lower than 9%. Thus, if the aperture ratio is 5%, the use efficiency of reflected light can be 95% and also high use efficiency of backlight can be obtained by the effect of the microlens array 200. Thus, it is easy to draw the design conditions of an optimal semi-transmissive liquid crystal display apparatus by defining the parameter P including the thickness t of the transparent substrate 102, incident angle θ and aperture diameter φ.

As described in the foregoing, the liquid crystal display apparatus according to the first embodiment of the invention can provide a liquid crystal display apparatus that exerts optical effects of a microlens array and increases light use efficiency, and a method of manufacturing the same. It allows obtaining light use efficiency of at east 50% or above.

In this embodiment, it is feasible to build a system to draw an optimal size in a semi-transmissive liquid crystal display apparatus by using the parameter P. This system at least includes a condition input section, a calculation section, a result display section and a control section. If an emission angle θ, refractive index n, aperture diameter φ and a thickness t of a transparent substrate are input through the condition input section, the calculation section calculates use efficiency E of backlight by using the parameter P and the result display section displays a calculation result of the use efficiency E. The control section controls a series of processing.

Further, it is feasible to calculate an optimal value for an undetermined value by inputting the use efficiency E of desired backlight and inputting the obtained value of the values to determine the parameter P.

### Seventh Embodiment

A seventh embodiment of the present invention describes another form of a backlight unit that is described in the first embodiment. The backlight unit of this embodiment is a direct backlight unit having a planar light source. The same reference symbols as in the first embodiment designate the same or similar elements and the description is omitted.

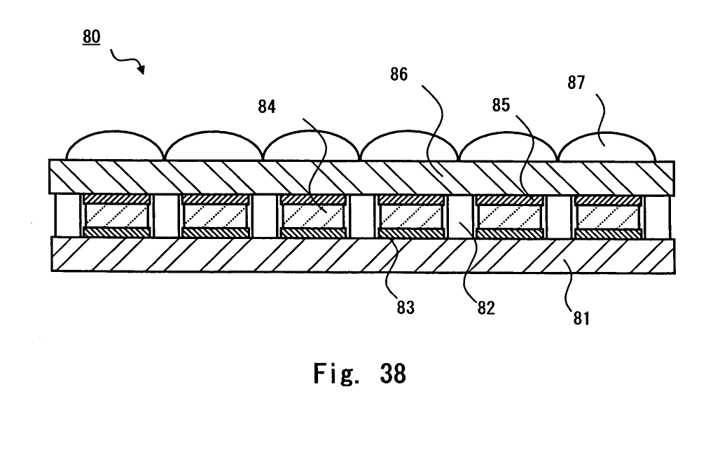

FIG. 38 is a sectional view showing the backlight unit 80 of this embodiment. The backlight unit 80 of this embodiment includes a transparent substrate 81, a partition 82, a metal electrode 83, an organic EL material 84, a transparent electrode 85, a transparent substrate 86, and a microlens 87. The transparent substrates 81 and 86 may be formed by glass, polycarbonate, acrylic resin, and so on. The partition 82 is formed on the transparent substrate 81, and the metal electrode 83 is formed along the partition 82. Further, the organic EL material 84 is filled into the part sectioned by the partition 82 from the upper part of the metal electrode 83.

The transparent electrode 85 is formed on the transparent substrate 86, and the transparent substrate 86 is then placed on the partition 82 so that the transparent electrode 85 and the organic EL material 84 contact each other, thereby sealing the organic EL material 84. Further, the microlens 87 is formed on the outside of the transparent substrate 86 at the same pitch as the partition 82. The focal point of the microlens 87 is substantially the same as the thickness of the transparent substrate 86. The microlens 87 may be formed on a different transparent substrate from the transparent substrate 86 by the 2P process and attached at the same pitch as the partition 82. In this case, the focal point of the microlens 87 is a sum of the thickness of the substrate where the microlens 87 is formed and the thickness of the transparent substrate 86.

The operation of the backlight unit 80 is described below. If a voltage is applied between the metal electrode 83 and the transparent electrode 85, the organic EL material 84 emits light. The light emitted inside each partition 82 passes through the transparent electrode 85 and the transparent electrode 86 and then enters the microlens 87. Since the focal point of the microlens 87 is substantially the same as the thickness of the transparent substrate 86, the light emitted inside each partition 82 becomes parallel light by passing through the microlens 87. The liquid crystal panel 100 is placed at the side of the microlens 87, thereby applying the parallel light 0 as backlight to the liquid crystal panel 10.

As described in the foregoing, this embodiment can provide a liquid crystal display apparatus that has a backlight unit capable of emitting vertically-polarized backlight.

Though the example of FIG. 38 uses the organic EL material as a light emitting element, the present invention is not limited thereto. For example, use of a carbon nano tube to constitute a field emission panel allows achieving the same effect as this embodiment.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A method of fabricating a microlens array on a surface of a transparent substrate whose another surface has a wiring pattern formed to have a plurality of aperture portions at a predetermined interval by using an exposure substrate composed of a transparent supporting substrate and an exposure microlens array formed thereon, the method comprising:
forming a photosensitive resin layer on the surface of the transparent substrate opposite from the surf ace having the aperture portions;
placing the exposure substrate and the transparent substrate so that parallel light having an intensity distribution corresponding to a shape of the exposure microlens array is focused by the exposure microlens array and enters the transparent substrate through the aperture portions;
exposing the photosensitive resin layer by applying the parallel light to the photosensitive resin layer through the exposure substrate; and
developing the exposed photosensitive resin layer.

2. The method of fabricating a microlens array according to claim 1, wherein
the parallel light having the intensity distribution is obtained by passing the parallel light through a gray scale mask having a plurality of mask patterns where light transmittance changes from a center to a periphery.

3. A method of fabricating a microlens array on a first surface of a transparent substrate having a second surface where a wiring pattern is formed to have a plurality of aperture portions at a predetermined interval, the method comprising:
placing a gray scale mask having a plurality of mask patterns where light transmittance changes from a center to a periphery and an exposure substrate where microlenses are formed corresponding one to one with the mask patterns of the gray scale mask on a transparent supporting substrate on the second surface of the transparent substrate having the aperture portions so that each aperture portion, an optical axis of each microlens, and a center of each mask pattern are aligned, and light applied through the gray scale mask is focused by the microlenses formed on the exposure substrate and output from the aperture portions;
forming a photosensitive resin layer on the first surface of the transparent substrate; and
exposing the photosensitive resin layer by applying light through the exposure substrate and developing the photosensitive resin layer.

4. The method of fabricating a microlens array according to claim 2, wherein
the exposure substrate has a positioning member defining a space between the exposure microlens array and the surface of the transparent substrate having the wiring pattern, and
if a thickness of the transparent substrate is t₁, a refractive index of the transparent substrate is n₁, a thickness of the positioning member is t₂, and a refractive index of the positioning member is n₂, a focal length of the exposure microlens array is substantially the same as t₂, and a following condition is satisfied: 0.75<(t₁*n₁)/(t₂*n₂)<1.25.

5. The method of fabricating a microlens array according to claim 2, wherein
if given coordinate positions of a plane perpendicular to an optical axis of exposure light to expose the photosensitive resin layer are represented by x and y, a light intensity distribution of exposure light having passed through the gray scale mask and the exposure substrate is represented by Z, and a, b and c represent given real numbers, a following condition is satisfied:
Z=ah²+bh⁴+ch⁶, and
h=(x²+y²)^{1/2}.

6. The method of fabricating a microlens array according to claim 2, wherein the positioning member has a light shielding pattern on a surface different from the surface having the exposure microlens, and an aperture portion of the light shielding pattern and an optical axis of the exposure microlens substantially correspond in a vertical direction.

7. The method of fabricating a microlens array according to claim 2, wherein the exposure substrate and the gray scale mask are integrally formed.

8. The method of fabricating a microlens array according to claim 2, wherein the exposure substrate and the transparent substrate are placed with an air space therebetween.

9. The method of fabricating a microlens array according to claim 8, wherein, if a thickness of the transparent substrate is t₁, a refractive index of the transparent substrate is n₁, and a thickness of the air space is t₃, a focal length of the exposure microlens is substantially the same as t₃, and a following condition is satisfied: 0.75<(t₁*n₁)/t₃<1.25.

10. A method of fabricating a microlens array on a first surface of a transparent substrate having a second surface where a circuit element pattern having a plurality of aperture portions is formed, the method comprising:
forming a photosensitive resin layer on the first surface of the transparent substrate;
placing an exposure substrate where a plurality of exposure microlenses are formed at substantially the same pitch as a pitch of the aperture portions on the second surface of the transparent substrate;
placing a gray scale mask where a plurality of lens formation areas are formed at substantially the same pitch as the pitch of the aperture portions on the second surface of the transparent substrate;
exposing the photosensitive resin layer through the gray scale mask and the exposure substrate; and
developing the exposed photosensitive resin layer.

11. A grayscale mask with a lens, wherein
a gray scale mask is formed on one surface of a supporting substrate having transparency, and
an exposure microlens corresponding to a mask pattern of the gray scale mask is formed on another surface of the supporting substrate.

12. A grayscale mask with a lens, wherein
a gray scale mask is formed on one surface of a supporting substrate having transparency, and
an exposure microlens corresponding to a mask pattern of the gray scale mask is formed on the gray scale mask.

13. The grayscale mask with a lens according to claim 11, wherein
the mask pattern is composed of same lens formation areas, and
if given coordinate positions on a plane parallel to the substrate are represented by x and y whose origin is a center of the lens formation areas, a light intensity distribution of light having passed through the lens formation areas on the plane parallel to the substrate is represented by Z, Cn represents a given real number, m represents a given natural number, and k is zero or a given positive real number, a following condition is satisfied:
$$\begin{matrix}Z = k - {\sum }_{n = 1}^{m} {C}_{n} {h}^{2 n} & ( 1 ) \\ h = {( {x}^{2} + {y}^{2} )}^{1 / 2} \\ n = 1 , 2 , 3 , 4 , ⋯ & ( 2 )\end{matrix}$$

14. The grayscale mask with a lens according to claim 12, wherein
the mask pattern is composed of same lens formation areas, and
if given coordinate positions on a plane parallel to the substrate are represented by x and y whose origin is a center of the lens formation areas, a light intensity distribution of light having passed through the lens formation areas on the plane parallel to the substrate is represented by Z, Cn represents a given real number, m represents a given natural number, and k is zero or a given positive real number, a following condition is satisfied:
$$\begin{matrix}Z = k - {\sum }_{n = 1}^{m} {C}_{n} {h}^{2 n} & ( 1 ) \\ h = {( {x}^{2} + {y}^{2} )}^{1 / 2} \\ n = 1 , 2 , 3 , 4 , ⋯ & ( 2 )\end{matrix}$$

15. The grayscale mask with a lens according to claim 11, further comprising:
a positioning member defining a space between an exposed substrate and the exposure microlens in exposure.

16. The grayscale mask with a lens according to claim 12, further comprising:
a positioning member defining a space between an exposed substrate and the exposure microlens in exposure.

17. A method of fabricating a gray scale mask, comprising:
forming an original gray scale mask by coating photoemulsion on a transparent substrate;
placing a master gray scale mask having a master pattern with gradation on a predetermined position of the original gray scale mask;
exposing the original gray scale mask through the master pattern;
repeating the placing the master gray scale mask on an unexposed position of the original gray scale mask and the exposing the original gray scale mask until exposure on all areas to be exposed is completed: and
developing the original gray scale mask.

18. The method of fabricating a gray scale mask according to claim 17, wherein the master gray scale mask is placed on a predetermined position of the original gray scale mask through an alignment substrate.

19. The method of fabricating a gray scale mask according to claim 18, wherein the alignment substrate has a marking for positioning the master gray scale mask, and the master gray scale mask is placed on a predetermined position on the original gray scale mask by using the marking.

20. The method of fabricating a gray scale mask according to claim 17, wherein
the alignment substrate has a light shielding effect and includes a plurality of aperture portions corresponding to a size of the master pattern, and
the master gray scale mask is placed on the original gray scale mask so that the master pattern faces the aperture portions.

21. A method of fabricating a gray scale mask with gradation, comprising:
forming a dry plate by coating photoemulsion on a transparent substrate; and
applying laser light whose intensity is modulated in a plurality of tones according to the gradation onto the emulsion-coated surface of the dry plate.

22. A gray scale mask with gradation composed of a transparent substrate coated with photoemulsion and developed, wherein
the gradation comprises a continuous pattern of circular or polygonal shapes, and one circular or polygonal shape has light transmittance sequentially changing to increase or decrease from a center to a periphery.

23. The gray scale mask according to claim 22, wherein
if coordinate positions on a principal plane of the gray scale mask are represented by x and y whose origin is a center of a pattern corresponding to one microlens, a light intensity distribution of light having passed through the pattern on the principal plane of the gray scale mask is represented by Z, Cn represents a given real number, m represents a given natural number, and k is zero or a given positive real number, a following condition is satisfied:
$$\begin{matrix}Z = k - {\sum }_{n = 1}^{m} {C}_{n} {h}^{2 n} & ( 1 ) \\ h = {( {x}^{2} + {y}^{2} )}^{1 / 2} \\ n = 1 , 2 , 3 , 4 , ⋯ & ( 2 )\end{matrix}$$

24. A semi-transmissive liquid crystal display apparatus, comprising:
a liquid crystal layer; and
a transparent substrate whose one surface has a pixel electrode including a reflecting portion and an aperture portion and whose another surface has a plurality of microlenses directly formed by photocurable resin and having a noncircular bottom shape, wherein
an aperture ratio of the aperture portion is in a range of 5% to 50%,
a filling rate of the microlenses with respect to a display area of the liquid crystal display apparatus is 70% and higher, and
if a maximum curvature radius of a lens section at a given line segment passing through a lens center of the microlenses is R1, and a minimum curvature radius of the same is R2, a ratio of R1 and R2 is in a range of 0.82 to 1.0.

25. The liquid crystal display apparatus according to claim 24, wherein a filling rate of the microlenses with respect to the display area of the liquid crystal display apparatus is 80% and higher.

26. The liquid crystal display apparatus according to claim 24, wherein the aperture ratio of the aperture portion is in a range of 5% to 20%.

27. The liquid crystal display apparatus according to claim 24, wherein the ratio of R1 and R2 is in a range of 0.9 to 1.0.

28. The liquid crystal display apparatus according to claim 24, if a curved line of a section of a given line segment passing through the lens center of the microlenses and connecting both ends of the microlens is r1 and a curved line of a spherical surface after fitting by method of least squares on r1 is r2, rms value of a difference between r1 and r2 is in a range of 0.005 to 0.2.

29. The liquid crystal display apparatus according to claim 28, wherein rms value of the difference between r1 and r2 is in a range of 0.005 to 0.15

30. The liquid crystal display apparatus according to claim 24, wherein a backlight is placed so that an emitting surface faces the surface of the transparent substrate having the microlens.

31. A semi-transmissive liquid crystal display apparatus comprising:
a liquid crystal layer;
a transparent substrate whose one surface has a pixel electrode including a reflecting portion and an aperture portion and whose another surface has a microlens aligned one to one with the aperture portion, and
a backlight unit placed so that an emitting surface faces the surface of the transparent substrate having the microlens, wherein
if an angle of an emission component of light from the backlight unit whose intensity is 20% of light intensity of a vertical component is defined as an emission angle θ of the backlight unit, a thickness of the transparent substrate to the backlight unit is t, an average length from a center of the aperture portion to a periphery of the aperture portion is φ/2, and a refractive index of the transparent substrate and/or the microlens is n, 0.85≦(φ*n)/(θ*t).

32. The semi-transmissive liquid crystal display apparatus according to claim 31, wherein a bottom shape of the microlens is hexagon or rectangle.

33. The semi-transmissive liquid crystal display apparatus according to claim 31, wherein the microlens is formed directly on the transparent substrate.

34. The semi-transmissive liquid crystal display apparatus according to claim 31, wherein (φ*n)/(θ*t)≦1.75.
